(19) United States
(12) Patent Application Publication
(10) Pub. No.: US 2026/0358024 A1
(43) Pub. Date: Nov. 12, 2026

(54) COOLING APPARATUS AND CONTROL METHOD THEREOF

(71) Applicant: SAMSUNG ELECTRONICS CO., LTD., Suwon-si (KR)

(72) Inventors: Joosik JUNG, Suwon-si (KR); Heemoon JEONG, Suwon-si (KR); Hyeonwoo SON, Suwon-si (KR)

(73) Assignee: SAMSUNG ELECTRONICS CO., LTD., Suwon-si (KR)

(21) Appl. No.: 19/716,908

(22) Filed: Jun. 23, 2026

Related U.S. Application Data
(63) Continuation of application No. PCT/KR2026/003300, filed on Feb. 27, 2026.

(30) Foreign Application Priority Data
Apr. 29, 2025 (KR) 10-2025-0056269
Nov. 28, 2025 (KR) 10-2025-0186350

(51) Int. Cl. F25B 21/00

(52) U.S. Cl. CPC F25B 21/00; F25B 2321/0022

(57) ABSTRACT

A cooling apparatus includes: a magnetic regeneration portion configured to receive a magnetocaloric material therein, the magnetic regeneration portion including a plurality of ports, the plurality of ports configured to have a refrigerant pass therethrough; a magnet configured to rotate around the magnetic regeneration portion on an outside of the magnetic regeneration portion; and a valve on a first side of the magnetic regeneration portion, the valve configured to rotate in conjunction with rotation of the magnet, wherein the valve includes at least one valve cover configured to open or close some ports, which are adjacent to each other among the plurality of ports, based on rotation of the valve.

### CROSS-REFERENCE TO RELATED APPLICATIONS

This application is a bypass continuation of International Patent Application No. PCT/KR2026/003300, filed on Feb. 27, 2026, which claims priority to Korean Patent Application No. 10-2025-0056269, filed in the Korean Intellectual Property Office on Apr. 29, 2025, and Korean Patent Application No. 10-2025-0186350, filed in the Korean Intellectual Property Office on Nov. 28, 2025, the disclosures of which are herein incorporated by reference in their entireties.

### BACKGROUND

### 1. Field

Some embodiments of the present disclosure relate to a cooling apparatus including an improved structure and a control method thereof.

### 2. Description of Related Art

Generally, home appliances such as a refrigerator and an air conditioner may include a cooling apparatus to supply cold air to a space that requires cooling. For example, the refrigerator may include a cooling apparatus to supply cold air to food storage compartments to keep food fresh for long periods of time. The air conditioner may also include a cooling apparatus to supply cold air to indoor spaces to regulate temperature and humidity levels to be appropriate for human activity.

A refrigerator and air conditioner may utilize a refrigeration cycle device that repeatedly compresses and expands a refrigerant. However, recent efforts to apply a cooling apparatus, such as Active Magnetic Regeneration devices (ARMs), into the refrigeration cycle device are increasing.

The cooling apparatus may transfer heat using magnetocaloric materials (MCMs), in which a temperature changes during magnetization and demagnetization. The cooling apparatus may not use a refrigerant and thus when the cooling apparatus is applied to the refrigeration cycle device, emission of harmful gas, which may be generated during an operation of the refrigeration cycle device, may be reduced.

### SUMMARY

According to some embodiments of the present disclosure, a cooling apparatus including a magnetocaloric material and a control method thereof may be provided.

According to some embodiments of the present disclosure, a cooling apparatus including a rotary valve configured to open and close a plurality of ports of a magnetic generating portion as the rotary valve rotates, and a control method thereof, may be provided.

Additional aspects of the present disclosure will be set forth in part in the description which follows and will be understood from the description or may be learned by practice of the present disclosure.

According to some embodiments of the present disclosure, a cooling apparatus includes: a magnetic regeneration portion configured to receive a magnetocaloric material therein, the magnetic regeneration portion including a plurality of ports, the plurality of ports configured to have a refrigerant pass therethrough; a magnet configured to rotate around the magnetic regeneration portion on an outside of the magnetic regeneration portion; and a valve on a first side of the magnetic regeneration portion, the valve configured to rotate in conjunction with rotation of the magnet, wherein the valve includes at least one valve cover configured to open or close some ports, which are adjacent to each other among the plurality of ports, based on rotation of the valve.

According to some embodiments of the present disclosure, a cooling apparatus may include: a magnetic regeneration portion configured to receive a magnetocaloric material; the magnetic regeneration portion including a plurality of ports, the plurality of ports configured to have a refrigerant pass therethrough; a magnet configured to rotate around the magnetic regeneration portion such as to form a magnetic field in the magnetic regeneration portion; and a valve on one side of the magnetic regeneration portion, the valve configured to open and close the plurality of ports and rotate in conjunction with rotation of the magnet.

According to some embodiments of the present disclosure, a method performed by at least one processor may include: rotating a motor of a cooling apparatus, wherein the rotating includes: causing a magnet of the cooling apparatus to rotate around a magnetic regeneration portion of the cooling apparatus such as to form a magnetic field in the magnetic regeneration portion, wherein the magnetic regeneration portion includes a magnetocaloric material and a plurality of ports, the plurality of ports configured to have a refrigerant pass therethrough; and causing a valve of the cooling apparatus to open or close the plurality of ports and rotate in conjunction with rotation of the magnet, wherein the valve is on one side of the magnetic regeneration portion.

### BRIEF DESCRIPTION OF DRAWINGS

FIG. 1 is a schematic view of a refrigeration cycle device according to an embodiment.

FIG. 2 is a perspective view of a cooling apparatus according to an embodiment.

FIG. 3 is a perspective view of a cooling module according to an embodiment.

FIG. 4 is a cross-sectional view taken along a line A-A′ shown in FIG. 3.

FIG. 5 is an exploded perspective view illustrating a state in which the cooling module according to an embodiment is disassembled into a main body unit, a first bracket, a second bracket, a first cover unit, and a second cover unit.

FIG. 6 is an exploded perspective view of the main body unit according to an embodiment.

FIG. 7 is an exploded perspective view of the first cover unit and the first bracket according to an embodiment.

FIG. 8 is an exploded perspective view of the second cover unit and the second bracket according to an embodiment.

FIG. 9 is a cross-sectional view illustrating a state in which a heating flow path is formed inside a magnetic regeneration pipe according to an embodiment.

FIG. 10 is a cross-sectional view illustrating a state in which a cooling flow path is formed inside the magnetic regeneration pipe according to an embodiment.

FIG. 11 is a cross-sectional view of a magnetic regeneration pipe according to an embodiment.

FIG. 12 is a cross-sectional view of a magnetic regeneration pipe according to an embodiment.

FIG. 13 is a cross-sectional view of a magnetic regeneration pipe according to an embodiment.

FIG. 14 is a view illustrating a plurality of magnetic regeneration pipes and a rotary valve according to an embodiment.

FIG. 15 is a view illustrating a state in which the rotary valve according to an embodiment is in a first position.

FIG. 16 is a view illustrating a state in which the rotary valve according to an embodiment is in a second position.

FIG. 17 is an enlarged view of a portion of a cross-section along a line B-B′ shown in FIG. 3.

FIG. 18 is an enlarged view of a portion of a cross-section along the line A-A′ shown in FIG. 3.

FIG. 19 is a control diagram of the refrigeration cycle device according to an embodiment.

FIG. 20 is a flowchart illustrating a control method of the refrigeration cycle device according to an embodiment.

FIG. 21 is a view illustrating a magnetic regeneration portion and a rotary valve according to an embodiment.

FIG. 22 is a view illustrating a magnetic regeneration portion and a rotary valve according to an embodiment.

FIG. 23 is a view illustrating a magnetic regeneration portion and a rotary valve according to an embodiment.

FIG. 24 is a cross-sectional view of a refrigerator according to an embodiment.

FIG. 25 is a perspective view of an air conditioner according to an embodiment.

FIG. 26 is an exploded perspective view of an outdoor unit of the air conditioner according to an embodiment.

### DETAILED DESCRIPTION

The various example embodiments and the terms used in the present disclosure are not intended to limit embodiments of the present disclosure to specific forms, and the present disclosure should be understood to include various modifications, equivalents, and/or alternatives to the corresponding example embodiments.

In describing the drawings, similar reference numerals may be used to designate similar constituent elements.

A singular expression may include a plural expression unless otherwise indicated herein or clearly contradicted by context.

The expressions “A or B,” “at least one of A or/and B,” or “one or more of A or/and B,” A, B or C,” “at least one of A, B or/and C,” or “one or more of A, B or/and C,” and the like used herein may include any and all combinations of one or more of the associated listed items.

The term of “and/or” includes a plurality of combinations of relevant items or any one item among a plurality of relevant items.

Herein, the expressions “a first,” “a second,” “the first,” “the second,” etc., may simply be used to distinguish an element from other elements, but is not limited to another aspect (e.g., importance or order) of elements.

When an element (e.g., a first element) is referred to as being “(functionally or communicatively) coupled,” or “connected” to another element (e.g., a second element), the first element may be connected to the second element, directly (e.g., wired), wirelessly, or through a third element.

In the present disclosure, the terms “including,” “comprising,” “having,” and the like are used to specify features, numbers, steps, operations, elements, components, or combinations thereof, but do not preclude the presence or addition of one or more of the features, elements, steps, operations, elements, components, or combinations thereof.

When an element is said to be “connected,” “coupled,” “supported,” or “contacted” with another element, this includes not only when elements are directly connected, coupled, supported, or contacted, but also when elements are indirectly connected, coupled, supported, or contacted through a third element.

Throughout the description, when an element is “on” another element, this includes not only when the element is in contact with the other element, but also when there is another element between the two elements.

Terms such as “portion,” “module,” and “member” may be embodied as hardware or software. According to embodiments, a plurality of “portions,” “modules,” and “members” may be implemented as a single component or a single “portion,” “module,” and “member” may include a plurality of components.

In the following description, terms such as “unit,” “part,” “block,” “member,” and “module” may indicate a unit for processing at least one function or operation. For example, these terms may refer to hardware (e.g., a Field Programmable Gate Array (FPGA) or an Application Specific Integrated Circuit (ASIC)) and/or software stored in a memory or a processor that is configured to perform the at least one function or operation.

Each step of methods described in the present disclosure may be implemented in an order different from the described order unless the context clearly indicates otherwise.

In the following detailed description, the terms of “front and rear direction,” “left and right direction,” “upper side,” “lower side,” and the like may be defined based on the drawings, but the shape and the location of elements are not limited by such terms.

For example, the X direction may be defined as the front and rear direction. For example, the Y direction may be defined as the lateral direction. For example, the Z direction may be defined as the up and down direction. For example, the +X direction may be defined as the front direction and the −X direction may be defined as the rear direction. For example, the +Y direction may be defined as the left direction and the −Y direction may be defined as the right direction. For example, the +Z direction may be defined as the upper direction and the −Z direction may be defined as the lower direction.

Hereinafter, non-limiting example embodiments of the present disclosure will be described in detail with reference to the accompanying drawings.

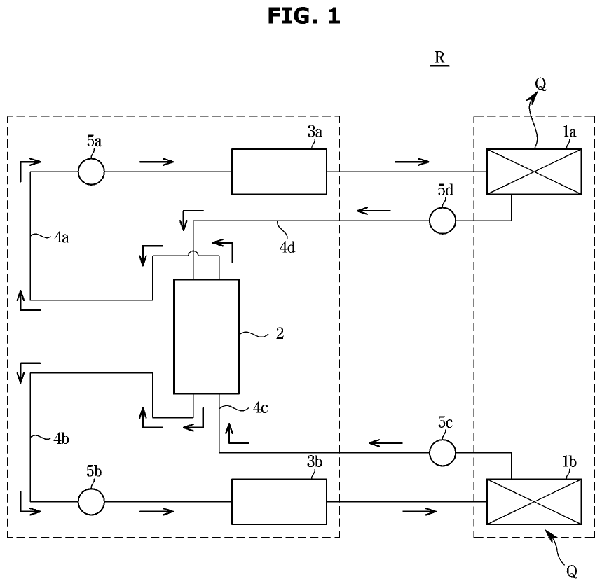

FIG. 1 is a schematic view of a refrigeration cycle device according to an embodiment.

Referring to FIG. 1, a refrigeration cycle device R may include a first heat exchanger 1a and a second heat exchanger 1b. The first heat exchanger 1a may be configured to release heat. The second heat exchanger 1b may be configured to absorb heat.

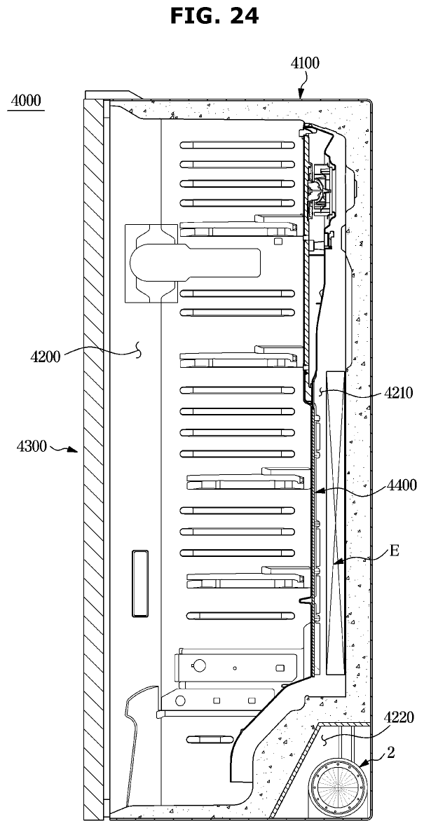

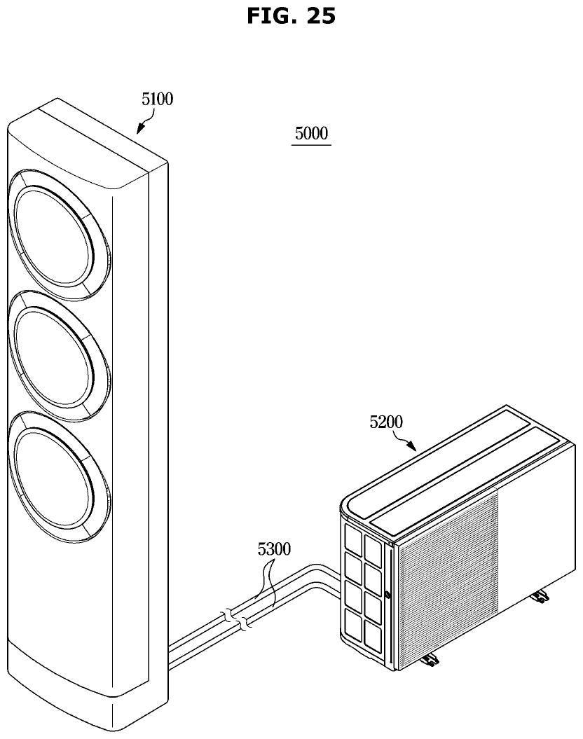

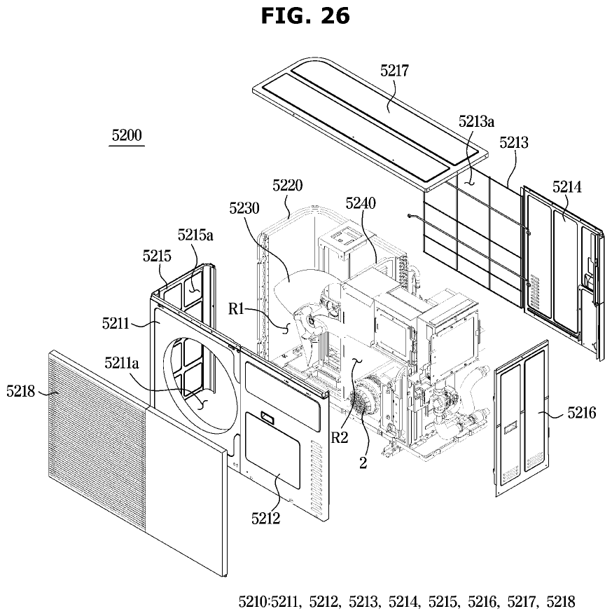

For example, when a home appliance including the refrigeration cycle device R is a refrigerator 4000, the first heat exchanger 1a may release heat to an outside of a main body 4100, and the second heat exchanger 1b may absorb heat from air flowing into a storage compartment 4200 (refer to FIG. 24). In addition, for example, when a home appliance including the refrigeration cycle device R is an air conditioner 5000, the first heat exchanger 1a may be installed in an outdoor unit 5200 to release heat to an outside of the outdoor unit 5200, and the second heat exchanger 1b may be installed in an indoor unit 5100 to absorb heat from air flowing into an indoor space (refer to FIGS. 25 and 26).

The refrigeration cycle device R may include a cooling apparatus 2. The cooling apparatus 2 may heat a refrigerant flowing to the first heat exchanger 1a and cool a refrigerant flowing to the second heat exchanger 1b.

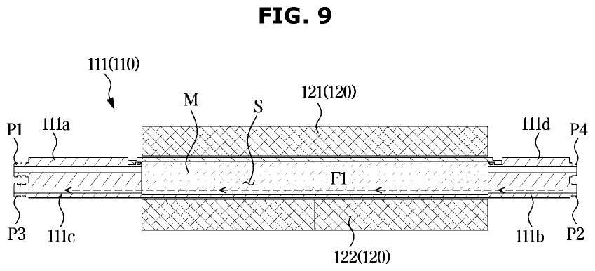

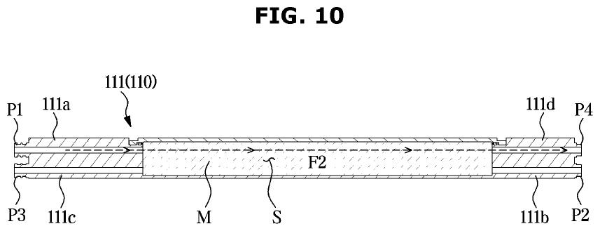

The cooling apparatus 2 may cool and heat the refrigerant flowing through the cooling apparatus 2 by utilizing a magnetocaloric effect. Particularly, the cooling apparatus 2 may cool and heat the refrigerant flowing through the cooling apparatus 2 by utilizing a magnetocaloric material M (refer to FIGS. 9 and 10) in which a temperature changes during magnetization and demagnetization processes. In the present description, the cooling apparatus 2 may also be referred to as a magnetic cooling apparatus.

In the refrigeration cycle device R including the cooling apparatus 2, water or antifreeze, and the like, may be used as a refrigerant. Accordingly, an amount of harmful gas emitted during an operation of the refrigeration cycle device R may be reduced.

The refrigeration cycle device R may include tanks (e.g., a first tank 3a and a second tank 3b). The tanks (e.g., the first tank 3a and the second tank 3b) may store a refrigerant flowing through the refrigeration cycle device R.

A plurality of tanks may be provided. The plurality of tanks may include a first tank 3a and a second tank 3b.

The first tank 3a may store a refrigerant before flowing to the first heat exchanger 1a. For example, the first tank 3a may be positioned upstream of the first heat exchanger 1a and downstream of the cooling apparatus 2.

The second tank 3b may store a refrigerant before the refrigerant flows to the second heat exchanger 1b. For example, the second tank 3b may be positioned upstream of the second heat exchanger 1b and downstream of the cooling apparatus 2.

A valve may be installed in the first tank 3a to control a flow rate and a direction of the refrigerant flowing to the first heat exchanger 1a. A valve may be installed in the second tank 3b to control a flow rate and a direction of the refrigerant flowing to the second heat exchanger 1b.

The refrigeration cycle device R may include pipes (e.g., a first pipe 4a, a second pipe 4b, a third pipe 4c, and a fourth pipe 4d). The pipes (e.g., the first pipe 4a, the second pipe 4b, the third pipe 4c, and the fourth pipe 4d) may connect the plurality of heat exchangers (e.g., the first heat exchanger 1a and the second heat exchanger 1b), the plurality of tanks (e.g., the first tank 3a and the second tank 3b), and the cooling apparatus 2. The refrigerant may flow within the pipes (e.g., the first pipe 4a, the second pipe 4b, the third pipe 4c, and the fourth pipe 4d).

A plurality of pipes may be provided. The plurality of pipes may include a first pipe 4a, a second pipe 4b, a third pipe 4c, and a fourth pipe 4d.

The first pipe 4a may connect the cooling apparatus 2 and the first heat exchanger 1a. The first pipe 4a may allow the refrigerant to flow from the cooling apparatus 2 to the first heat exchanger 1a through the first tank 3a.

The second pipe 4b may connect the cooling apparatus 2 and the second heat exchanger 1b. The second pipe 4b may allow the refrigerant to flow from the cooling apparatus 2 to the second heat exchanger 1b through the second tank 3b.

The third pipe 4c may connect the cooling apparatus 2 and the second heat exchanger 1b. The third pipe 4c may allow the refrigerant to flow from the second heat exchanger 1b to the cooling apparatus 2.

The fourth pipe 4d may connect the cooling apparatus 2 and the first heat exchanger 1a. The fourth pipe 4d may allow the refrigerant to flow from the first heat exchanger 1a to the cooling apparatus 2.

The refrigeration cycle device R may include pumps (e.g., a first pump 5a, a second pump 5b, a third pump 5c, and a fourth pump 5d). The pumps (e.g., the first pump 5a, the second pump 5b, the third pump 5c, and the fourth pump 5d) may be installed in the pipes (e.g., the first pipe 4a, the second pipe 4b, the third pipe 4c, and the fourth pipe 4d). The pumps (e.g., the first pump 5a, the second pump 5b, the third pump 5c, and the fourth pump 5d) may be configured to pump a working refrigerant to allow the refrigerant to flow to each component of the refrigeration cycle device R.

A plurality of pumps may be provided. The plurality of pumps may include a first pump 5a, a second pump 5b, a third pump 5c, and a fourth pump 5d.

The first pump 5a may be installed in the first pipe 4a. The first pump 5a may be configured to pump the refrigerant flowing from the cooling apparatus 2 to the first heat exchanger 1a.

The second pump 5b may be installed in the second pipe 4b. The second pump 5b may be configured to pump the refrigerant flowing from the cooling apparatus 2 to the second heat exchanger 1b.

The third pump 5c may be installed in the third pipe 4c. The third pump 5c may be configured to pump the refrigerant flowing from the second heat exchanger 1b to the cooling apparatus 2.

The fourth pump 5d may be installed in the fourth pipe 4d. The fourth pump 5d may be configured to pump the refrigerant flowing from the first heat exchanger 1a to the cooling apparatus 2.

However, the positions of the pumps (e.g., the first pump 5a, the second pump 5b, the third pump 5c, and the fourth pump 5d) are not limited thereto. For example, the third pump 5c may be installed in the second pipe 4b to pump the refrigerant flowing to the second heat exchanger 1b, and the fourth pump 5d may be installed in the first pipe 4a to pump the refrigerant flowing to the first heat exchanger 1a.

In the refrigeration cycle device R, the refrigerant may circulate through the refrigeration cycle device R. For example, the refrigerant may sequentially pass through the first heat exchanger 1a, the cooling apparatus 2, the second heat exchanger 1b, and the cooling apparatus 2 and then flow back to the first heat exchanger 1a.

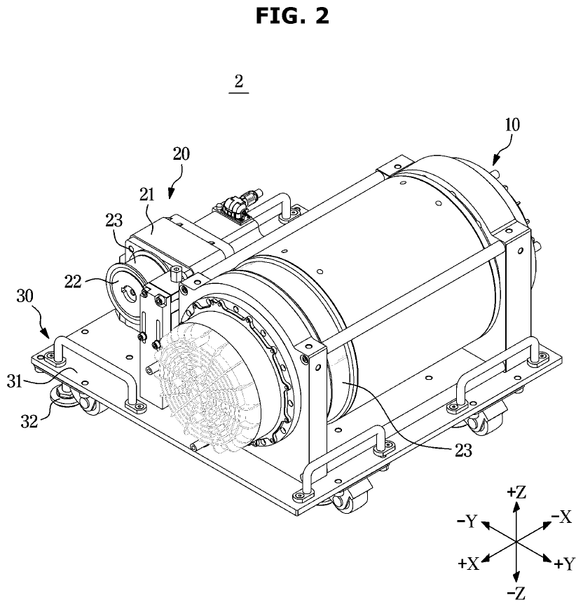

FIG. 2 is a perspective view of a cooling apparatus according to an embodiment.

Referring to FIG. 2, the cooling apparatus 2 may include a cooling module 10. The cooling module 10 may be configured to cool and heat the refrigerant flowing through the cooling apparatus 2 by utilizing the magnetocaloric effect. In other words, the cooling module 10 may cool and heat the refrigerant flowing through the cooling module 10 by utilizing the magnetocaloric effect.

The cooling apparatus 2 may include a power transmission portion 20 (e.g., a power transmitter). The power transmission portion 20 may be configured to transmit power to the cooling module 10. The power transmission portion 20 may include a motor 21, a pulley 22, and a belt 23. The belt 23 may be mounted on the pulley 22, and the motor 21 may rotate the pulley 22. Accordingly, the belt 23 may drive in a specific direction.

The cooling apparatus 2 may include a support 30. The support 30 may be provided to support the cooling module 10 and the power transmission portion 20.

The support 30 may include a support plate 31 and a support leg 32. The cooling module 10 and the power transmission portion 20 may be installed on the support plate 31. The support leg 32 may be provided to support the support plate 31 from a lower side of the support plate 31. A plurality of support legs 32 may be provided.

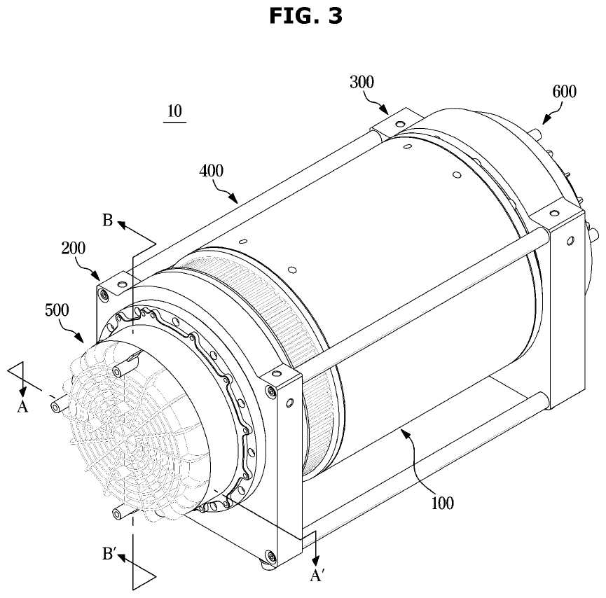

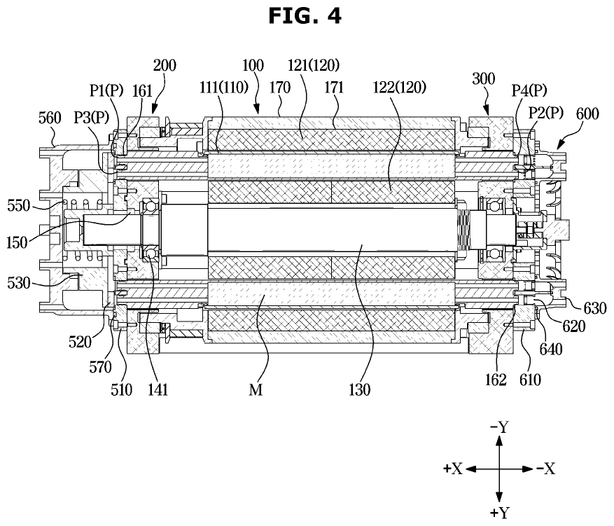

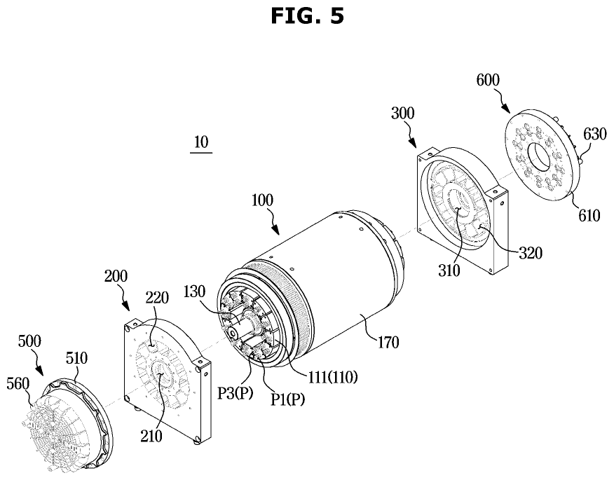

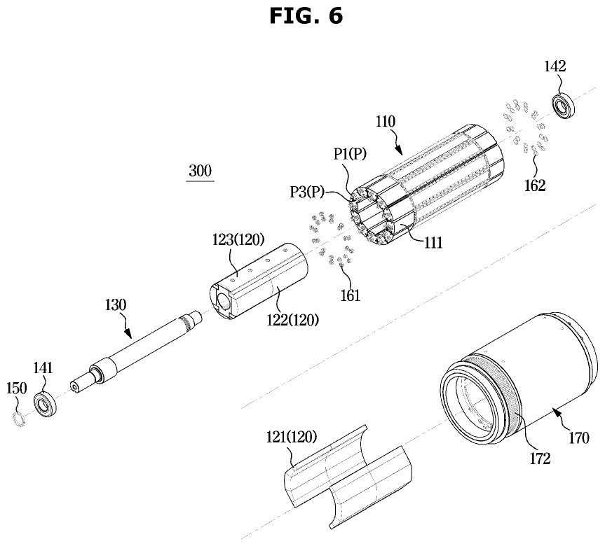

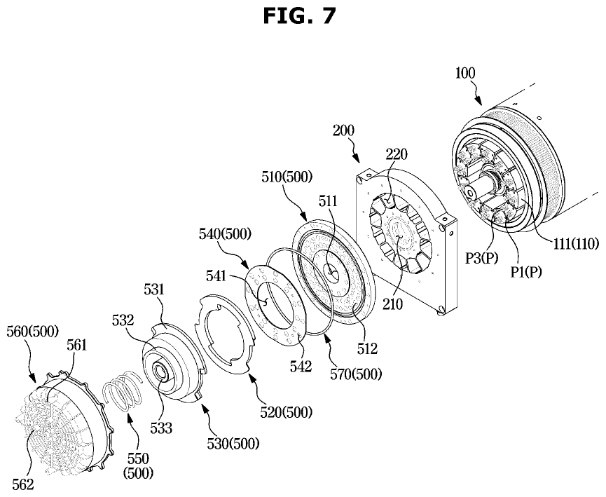

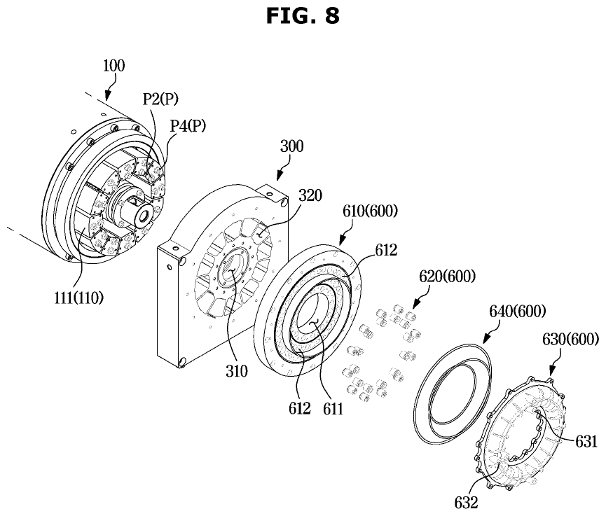

FIG. 3 is a perspective view of a cooling module according to an embodiment. FIG. 4 is a cross-sectional view taken along a line A-A′ shown in FIG. 3. FIG. 5 is an exploded perspective view illustrating a state in which the cooling module according to an embodiment is disassembled into a main body unit, a first bracket, a second bracket, a first cover unit, and a second cover unit. FIG. 6 is an exploded perspective view of the main body unit according to an embodiment. FIG. 7 is an exploded perspective view of the first cover unit and the first bracket according to an embodiment. FIG. 8 is an exploded perspective view of the second cover unit and the second bracket according to an embodiment.

The cooling module 10 may include a main body unit 100, a first bracket 200, a second bracket 300, a bracket rod 400, a first cover unit 500, and a second cover unit 600.

The main body unit 100 may be configured to cool and heat a refrigerant flowing through the cooling module 10 by utilizing the magnetocaloric effect. The main body unit 100 may include components such as a magnetic regeneration portion 110 provided to receive a magnetocaloric material M therein, and at least one magnet 120 configured to form a magnetic field in the magnetic regeneration portion 110.

The first bracket 200 may be provided to support the main body unit 100. Particularly, the first bracket 200 may be provided to support one side of the main body unit 100. The first bracket 200 may be coupled to the main body unit 100.

The second bracket 300 may be provided to support the main body unit 100. Particularly, the second bracket 300 may be provided to support the other side of the main body unit 100. The second bracket 300 may be coupled to the main body unit 100.

The first bracket 200 and the second bracket 300 may be fixed to the support plate 31. By fixing the first bracket 200 and the second bracket 300 to the support plate 31, the cooling module 10 may be installed on the support plate 31 (refer to FIG. 2).

The bracket rod 400 may support the first bracket 200 and the second bracket 300. The bracket rod 400 may connect the first bracket 200 and the second bracket 300 to each other. A plurality of bracket rods 400 may be provided. With the configuration, the main body unit 100, the first bracket 200, and the second bracket 300 may be firmly coupled to each other.

The first cover unit 500 may cover one side of the first bracket 200. The first cover unit 500 may be provided on one side of the first bracket 200. The first cover unit 500 may be coupled to the first bracket 200.

In other words, the first cover unit 500 may cover one side of the main body unit 100. The first cover unit 500 may be provided on one side of the main body unit 100. For example, a portion of the main body unit 100 may penetrate the first bracket 200, and the first cover unit 500 may cover a portion of the main body unit 100 that penetrates the first bracket 200.

The second cover unit 600 may cover the other side of the second bracket 300. The second cover unit 600 may be provided on the other side of the second bracket 300. The second cover unit 600 may be coupled to the second bracket 300.

In other words, the second cover unit 600 may cover the other side of the main body unit 100. The second cover unit 600 may be provided on the other side of the main body unit 100. For example, another portion of the main body unit 100 may penetrate the second bracket 300, and the second cover unit 600 may cover another portion of the main body unit 100 that penetrates the second bracket 300.

The main body unit 100 may include the magnetic regeneration portion 110. A refrigerant may flow within the magnetic regeneration portion 110. The magnetic regeneration portion 110 may cool and heat the refrigerant flowing within the magnetic regeneration portion 110.

The magnetic regeneration portion 110 may receive the magnetocaloric material M. That is, the magnetocaloric material M may be provided inside the magnetic regeneration portion 110. Details regarding the magnetocaloric material M will be described below.

The magnetic regeneration portion 110 may include a port P. The port P may be provided to allow a refrigerant to pass therethrough. That is, the port P may be provided to introduce a refrigerant or discharge the refrigerant.

A plurality of ports P may be provided. The plurality of ports P may include inlet ports (e.g., a first inlet port P1 and a second inlet port P2) and outlet ports (e.g., a first outlet port P3 and a second outlet port P4). The inlet ports (e.g., the first inlet port P1 and the second inlet port P2) may be provided to allow a refrigerant to flow into the magnetic regeneration portion 110, and the outlet ports (e.g., the first outlet port P3 and the second outlet port P4) may be provided to discharge the refrigerant from the magnetic regeneration portion 110. Each of the inlet ports (e.g., the first inlet port P1 and the second inlet port P2) and the outlet ports (e.g., the first outlet port P3 and the second outlet port P4) may be provided in plural.

The magnetic regeneration portion 110 may include a magnetic regeneration pipe 111. The refrigerant may flow within the magnetic regeneration pipe 111. The magnetic regeneration pipe 111 may cool and heat the refrigerant flowing within the magnetic regeneration pipe 111. The magnetic regeneration pipe 111 may be formed to extend in one direction.

The magnetic regeneration pipe 111 may include a material having relatively weak magnetism. Further, the magnetic regeneration pipe 111 may include a material having relatively strong rigidity. With the configuration, the magnetic regeneration pipe 111 may not react to the at least one magnet 120 described below, but is not easily deformed by external forces such as magnetic force.

For example, the magnetic regeneration pipe 111 may include a material such as Polyphenylene Sulfide (PPS) or Polyether ether ketone (PEEK). However, the material of the magnetic regeneration pipe 111 is not limited thereto.

The magnetic regeneration pipe 111 may include the above-described inlet ports (e.g., the first inlet port P1 and the second inlet port P2) and outlet ports (e.g., the first outlet port P3 and the second outlet port P4). The inlet ports may include a first inlet port P1 and a second inlet port P2. The outlet ports may include a first outlet port P3 and a second outlet port P4.

The first inlet port P1 and the first outlet port P3 may be provided on one side of the magnetic regeneration pipe 111. The second inlet port P2 and the second outlet port P4 may be provided on the opposite side of the magnetic regeneration pipe 111. That is, the first inlet port P1 and the first outlet port P3 may be provided on opposite sides of the magnetic regeneration pipe 111 from the second inlet port P2 and the second outlet port P4.

The first inlet port P1 may be provided to allow a refrigerant to flow into a first case 560 described below. The first outlet port P3 may be provided to discharge the refrigerant into the first case 560 described below. The second inlet port P2 may be provided to allow the refrigerant to flow into a second case 630 described below. The second outlet port P4 may be provided to discharge the refrigerant into the second case 630 described below.

The first inlet port P1 and the first outlet port P3 may be spaced apart from each other along a direction intersecting an extension direction of the magnetic regeneration pipe 111. Particularly, the first inlet port P1 and the first outlet port P3 may be spaced apart from each other along a radial direction of a shaft 130 described below.

The first inlet port P1 may be provided more outward than the first outlet port P3. In other words, the first outlet port P3 may be provided more inward than the first inlet port P1.

However, the positions of the first inlet port P1 and the first outlet port P3 are not limited thereto. For example, the first inlet port P1 may be provided more inward than the first outlet port P3. However, the following description will be focused on an embodiment in which the first inlet port P1 is provided more outward than the first outlet port P3.

The second inlet port P2 and the second outlet port P4 may be spaced apart from each other along a direction intersecting the extension direction of the magnetic regeneration pipe 111. Particularly, the second inlet port P2 and the second outlet port P4 may be spaced apart from each other along the radial direction of the shaft 130 described below.

The second inlet port P2 may be provided more inward than the second outlet port P4. In other words, the second outlet port P4 may be provided more outwards than the second inlet port P2.

However, the positions of the second inlet port P2 and the second outlet port P4 are not limited thereto. For example, the second inlet port P2 may be provided more outwards than the second outlet port P4. However, the following description will be focused on an embodiment in which the second inlet port P2 is provided more inward than the second outlet port P4.

A plurality of magnetic regeneration pipes 111 may be provided. Accordingly, each of the first inlet port P1, the second inlet port P2, the first outlet port P3, and the second outlet port P4 may be provided in plurality.

The plurality of magnetic regeneration pipes 111 may be arranged in a circle with respect to each other. Particularly, the plurality of magnetic regeneration pipes 111 may be arranged along a circumferential direction of the shaft 130 described below.

A plurality of first inlet ports P1 and a plurality of first outlet ports P3 may be arranged in a circle along the plurality of magnetic regeneration pipes 111. Particularly, the plurality of first inlet ports P1 and the plurality of first outlet ports P3 may be arranged along the circumferential direction of the shaft 130 described below.

The plurality of second inlet ports P2 and the plurality of second outlet ports P4 may be arranged in a circle along the plurality of magnetic regeneration pipes 111. Particularly, the plurality of second inlet ports P2 and the plurality of second outlet ports P4 may be arranged along the circumferential direction of the shaft 130 described below.

The main body unit 100 may include the at least one magnet 120. The at least one magnet 120 may be configured to form a magnetic field in the magnetic regeneration portion 110.

The at least one magnet 120 may include a first magnet 121. The first magnet 121 may be provided on the outside of the magnetic regeneration portion 110.

The first magnet 121 may be configured to rotate around the magnetic regeneration portion 110. In other words, the first magnet 121 may be configured to rotate along a direction in which the plurality of magnetic regeneration pipes 111 is arranged. In other words, the first magnet 121 may be configured to rotate around the shaft 130 described below.

Two first magnets 121 may be provided. The two first magnets 121 may be provided on opposite sides with respect to the magnetic regeneration portion 110. In other words, the two first magnets 121 may be arranged to have a phase difference of 180 degrees with respect to the shaft 130 described below.

However, the number of first magnets 121 is not limited thereto. For example, a single first magnet 121 may be provided or three or more of first magnets 121 may be provided.

The at least one magnet 120 may include a second magnet 122. The second magnet 122 may be provided on the inner side of the magnetic regeneration portion 110.

The second magnet 122 may be configured to rotate around the same rotational axis as the first magnet 121. In other words, the second magnet 122 may be configured to rotate around the shaft 130 described below.

The second magnet 122 may be positioned to correspond to the first magnet 121. In other words, the first magnet 121 and the second magnet 122 may be positioned to face each other with a portion of the magnetic regeneration portion 110 interposed therebetween. With the configuration, a magnetic field may be formed in a portion of the magnetic regeneration portion 110 disposed between the first magnet 121 and the second magnet 122.

Two second magnets 122 may be provided. The two second magnets 122 may be provided on opposite sides with respect to the shaft 130 described below. In other words, the two first magnets 121 may be arranged to have a phase difference of 180 degrees with respect to the shaft 130.

However, the number of second magnets 122 is not limited thereto. For example, a single second magnet 122 may be provided or three or more of second magnets 122 may be provided.

In addition, the second magnet 122 may be omitted. In this case, a magnetic field may be formed in a portion of the magnetic regeneration portion 110 provided between the two first magnets 121.

A yoke 123 may be provided with the at least one magnet 120. The yoke 123 may be provided to support the second magnet 122. Particularly, the yoke 123 may be provided to support two second magnets 122. The yoke 123 may be configured to rotate together with the second magnet 122.

The second magnet 122 and the yoke 123 may be coupled to the shaft 130 described below. For example, the second magnet 122 and the yoke 123 may be coupled to approximately a center of the shaft 130.

The main body unit 100 may include the shaft 130. The shaft 130 may be configured to rotate. Particularly, the shaft 130 may be configured to rotate about a rotational axis extending in the same direction as the direction in which the magnetic regeneration pipe 111 extends.

The shaft 130 may extend in one direction. Particularly, the shaft 130 may extend in the same direction as the direction in which the magnetic regeneration pipe 111 extends.

The shaft 130 may form a rotational axis of the at least one magnet 120. Particularly, the shaft 130 may form the rotational axis of the first magnet 121, the second magnet 122, and the yoke 123.

The shaft 130 may be provided on an inner side of the second magnet 122 and the yoke 123. In other words, the shaft 130 may be provided on the inner side of the magnetic regeneration portion 110.

The main body unit 100 may include a first bearing 141. The first bearing 141 may be coupled to one end of the shaft 130. The first bearing 141 may be disposed between one end of the shaft 130 and the first bracket 200. The shaft 130 may be configured to be rotatable relative to the first bracket 200 via the first bearing 141.

The main body unit 100 may include a second bearing 142. The second bearing 142 may be coupled to the other end of the shaft 130. The second bearing 142 may be disposed between the other end of the shaft 130 and the second bracket 300. The shaft 130 may be configured to be rotatable relative to the second bracket 300 via the second bearing 142.

The main body unit 100 may include a shaft sealing member 150 (e.g., a shaft seal). The shaft sealing member 150 may be coupled to the shaft 130. The shaft sealing member 150 may be provided to prevent a refrigerant from flowing into an inner space of the magnetic regeneration portion 110.

Particularly, the shaft sealing member 150 may be coupled to one end of the shaft 130. The shaft sealing member 150 may be provided more inward than the first bearing 141.

The shaft sealing member 150 may be arranged between an outer surface of the shaft 130 and an inner surface of a first shaft insertion hole 210 described below. That is, the shaft sealing member 150 may seal between the outer surface of the shaft 130 and the inner surface of the first shaft insertion hole 210. With the configuration, a plurality of shaft sealing members 150 may prevent the refrigerant from flowing into a space between the shaft 130 and the first shaft insertion hole 210.

The main body unit 100 may include a first port sealing member 161 (e.g., a first port seal). The first port sealing member 161 may be provided to prevent a refrigerant, which passing through the first inlet port P1 or the first outlet port P3, from flowing into a space between the magnetic regeneration portion 110 and a housing 170 described below.

A plurality of first port sealing members 161 may be provided. Some of the plurality of first port sealing members 161 may surround each of the plurality of first inlet ports P1. Others of the plurality of first port sealing members 161 may surround each of the plurality of first outlet ports P3.

Some of the plurality of first port sealing members 161 may be respectively arranged between an outer surface of the first inlet port P1 and an inner surface of a first port insertion hole 512 described below. That is, some of the plurality of first port sealing members 161 may respectively seal between the outer surface of the first inlet port P1 and the inner surface of the first port insertion hole 512. With the configuration, some of the plurality of first port sealing members 161 may prevent the refrigerant from being introduced through a space between the first inlet port P1 and the first port insertion hole 512.

Others of the plurality of first port sealing members 161 may be respectively arranged between an outer surface of the first outlet port P3 and an inner surface of the first port insertion hole 512. That is, others of the plurality of first port sealing members 161 may seal between the outer surface of the first outlet port P3 and the inner surface of the first port insertion hole 512. With the configuration, others of the plurality of first port sealing members 161 may prevent the refrigerant from being introduced through a space between the first outlet port P3 and the first port insertion hole 512.

The main body unit 100 may include a second port sealing member 162 (e.g., a second port seal). The second port sealing member 162 may be provided to prevent a refrigerant, which is passing through the second inlet port P2 or the second outlet port P4, from flowing into the space between the magnetic regeneration portion 110 and the housing 170 described below.

A plurality of second port sealing members 162 may be provided. Some of the plurality of second port sealing members 162 may surround each of the plurality of second inlet ports P2. Others of the plurality of second port sealing members 162 may surround each of the plurality of second outlet ports P4.

Some of the plurality of second port sealing members 162 may be respectively arranged between an outer surface of the second inlet port P2 and an inner surface of a second port insertion hole 612 described below. That is, some of the plurality of second port sealing members 162 may seal between the outer surface of the second inlet port P2 and the inner surface of the second port insertion hole 612. With the configuration, some of the plurality of second port sealing members 162 may prevent the refrigerant from being introduced through a space between the second inlet port P2 and the second port insertion hole 612.

Others of the plurality of second port sealing members 162 may be respectively arranged between an outer surface of the second outlet port P4 and the inner surface of the second port insertion hole 612. That is, others of the plurality of second port sealing members 162 may seal between the outer surface of the second outlet port P4 and the inner surface of the second port insertion hole 612. With the configuration, others of the plurality of second port sealing members 162 may prevent the refrigerant from being introduced through a space between the second outlet port P4 and the second port insertion hole 612.

The main body unit 100 may include the housing 170. The housing 170 may be provided to receive various components of the main body unit 100 described above. For example, the housing 170 may be provided to receive at least a portion of the magnetic regeneration portion 110, and at least a portion of the at least one magnet 120 and the shaft 130.

The housing 170 may be provided in a hollow cylindrical shape. However, there is no particular limitation on the shape of the housing 170.

The housing 170 may be provided to support the first magnet 121. The first magnet 121 may be coupled to an inner surface of the housing 170. Particularly, a magnet receiving portion 171, which may be recessed, may be formed on the inner surface of the housing 170, and the first magnet 121 may be received in the magnet receiving portion 171 described above.

The housing 170 may be configured to rotate around the magnetic regeneration portion 110. In other words, the housing 170 may be configured to rotate along the direction in which the plurality of magnetic regeneration pipes 111 is arranged. In other words, the housing 170 may be configured to rotate around the shaft 130.

The housing 170 may include a belt mounting portion 172. The belt mounting portion 172 may be provided to allow the belt 23 (refer to FIG. 2) to be mounted thereon. The belt mounting portion 172 may be provided at (e.g., in or on) an outer surface of the housing 170.

As the belt 23 (refer to FIG. 2) moves, the housing 170 may rotate. For example, the housing 170 may rotate clockwise or counterclockwise about a rotational axis extending in the front and rear direction.

As the housing 170 rotates, the first magnet 121 may rotate. The first magnet 121 may rotate in the same rotational direction as the housing 170. The first magnet 121 may rotate at the same rotational angular velocity as the housing 170.

As the first magnet 121 rotates, the second magnet 122 and the yoke 123 may rotate. Particularly, the second magnet 122 and the yoke 123 may rotate due to the magnetic force between the first magnet 121 and the second magnet 122. The second magnet 122 and the yoke 123 may rotate in the same rotational direction as the first magnet 121. The second magnet 122 and the yoke 123 may rotate at the same rotational angular velocity as the first magnet 121.

As the second magnet 122 and the yoke 123 rotate, the shaft 130 may rotate. The shaft 130 may rotate in the same rotational direction as the second magnet 122 and the yoke 123. The shaft 130 may rotate at the same rotational angular velocity as the second magnet 122 and the yoke 123.

However, the rotation method of the housing 170, the at least one magnet 120, and the shaft 130 is not limited thereto. For example, the housing 170, the at least one magnet 120, and the shaft 130 may rotate through a power transmission portion including a plurality of gears.

The first bracket 200 may include the first shaft insertion hole 210. The first shaft insertion hole 210 may be provided to allow one end of the shaft 130 to be inserted thereinto. The first shaft insertion hole 210 may be formed approximately in the center of the first bracket 200.

The first bracket 200 may include a first magnetic regeneration pipe insertion hole 220. The first magnetic regeneration pipe insertion hole 220 may be provided to allow one end of the magnetic regeneration pipe 111 to be inserted thereinto.

A plurality of first magnetic regeneration pipe insertion holes 220 may be provided. The plurality of first magnetic regeneration pipe insertion holes 220 may be arranged in the first bracket 200 to respectively receive the plurality of magnetic regeneration pipes 111. The plurality of first magnetic regeneration pipe insertion holes 220 may be arranged in a circle with respect to the first shaft insertion hole 210.

The second bracket 300 may include a second shaft insertion hole 310. The second shaft insertion hole 310 may be provided to allow the other end of the shaft 130 to be inserted thereinto. The second shaft insertion hole 310 may be formed approximately in the center of the second bracket 300.

The second bracket 300 may include a second magnetic regeneration pipe insertion hole 320. The second magnetic regeneration pipe insertion hole 320 may be provided to allow the other end of the magnetic regeneration pipe 111 to be inserted thereinto.

A plurality of second magnetic regeneration pipe insertion holes 320 may be provided. The plurality of second magnetic regeneration pipe insertion holes 320 may be arranged in the second bracket 300 to respectively receive the plurality of magnetic regeneration pipes 111. The plurality of second magnetic regeneration pipe insertion holes 320 may be arranged in a circle with respect to the second shaft insertion hole 310.

The first cover unit 500 may include a first base plate 510. The first base plate 510 may be provided on one side of the first bracket 200. The first base plate 510 may be coupled to one side of the first bracket 200.

The first base plate 510 may include a third shaft insertion hole 511. The third shaft insertion hole 511 may be provided to allow one end of the shaft 130 to be inserted thereinto. The third shaft insertion hole 511 may be formed approximately at the center of the first base plate 510.

The first base plate 510 may include the first port insertion hole 512. The first port insertion hole 512 may be provided to allow the port P to be inserted thereinto. Particularly, the first port insertion hole 512 may be provided to allow the first inlet port P1 or the first outlet port P3 to be inserted thereinto.

A plurality of first port insertion holes 512 may be provided. The plurality of first inlet ports P1 may be inserted into some of the plurality of first port insertion holes 512, and the plurality of first outlet ports P3 may be inserted into others of the plurality of first port insertion holes 512.

The plurality of first port insertion holes 512 may be arranged in a circle with respect to the third shaft insertion hole 511. Particularly, some of the plurality of first port insertion holes 512 may be arranged along a direction in which the plurality of first inlet ports P1 is arranged, and others of the plurality of first port insertion holes 512 may be arranged along a direction in which the plurality of first outlet ports P3 is arranged.

The first cover unit 500 may include a valve 520. The valve 520 may be configured to open and close the plurality of ports P. Particularly, the valve 520 may be configured to open and close ports P provided on one side of the magnetic regeneration portion 110 among the plurality of ports P.

For example, the valve 520 may be configured to open and close the plurality of first inlet ports P1. For example, the valve 520 may be configured to open and close the plurality of first outlet ports P3.

The valve 520 may be provided on one side of the first base plate 510. In other words, the valve 520 may be provided on one side of the first bracket 200. In other words, the valve 520 may be provided on one side of the main body unit 100. In other words, the valve 520 may be provided on one side of the magnetic regeneration portion 110.

The valve 520 may be configured to rotate. Particularly, the valve 520 may be configured to rotate about the shaft 130. Accordingly, the valve 520 may be referred to as a rotary valve in the present description.

The valve 520 may rotate in conjunction with the rotation of the at least one magnet 120. For example, the valve 520 may rotate in conjunction with the rotation of the first magnet 121. For example, the valve 520 may rotate in conjunction with the rotation of the second magnet 122 and the yoke 123.

That is, the valve 520 may rotate as the at least one magnet 120 rotates. The valve 520 may rotate in the same rotational direction as the at least one magnet 120. The valve 520 may rotate at the same rotational angular velocity as the at least one magnet 120.

For example, the valve 520 may rotate in the same rotational direction as the first magnet 121. The valve 520 may rotate at the same rotational angular velocity as the first magnet 121.

For example, the valve 520 may rotate in the same rotational direction as the second magnet 122 and the yoke 123. The valve 520 may rotate at the same rotational angular velocity as the second magnet 122 and the yoke 123.

The valve 520 may include a PPS material. However, the material of the valve 520 is not limited thereto.

The first cover unit 500 may include a valve holder 530. The valve holder 530 may be provided to support the valve 520.

According to some embodiments of the present disclosure, the valve holder 530 and the valve 520 may be coupled. For example, the valve holder 530 may include a coupling protrusion protruding toward the valve 520, and the valve 520 may include a coupling groove into which the coupling protrusion may be inserted.

The valve holder 530 may include a holder base 531. The holder base 531 may be in contact with the valve 520.

The valve holder 530 may include a holder body 532. The holder body 532 may protrude from the holder base 531. Particularly, the holder body 532 may protrude from the other surface of the holder base 531 opposite to one surface of the holder base 531 that is in contact with the valve 520. For example, the holder body 532 may protrude from approximately a center of the holder base 531.

The valve holder 530 may include a shaft support 533. The shaft support 533 may be provided to support the shaft 130.

The shaft support 533 may be provided to allow one end of the shaft 130 to be inserted thereinto. That is, by inserting one end of the shaft 130 into the shaft support 533, the shaft support 533 may support the shaft 130.

In other words, the shaft support 533 may be coupled to the shaft 130. Therefore, the valve holder 530 including the shaft support 533 may rotate together with the shaft 130. That is, the valve holder 530 may rotate as the shaft 130 rotates.

As described above, the valve holder 530 may support the valve 520. Therefore, the valve 520 may rotate as the valve holder 530 rotates.

According to some embodiments of the present disclosure, the housing 170 may rotate due to the power transmission portion 20. As the housing 170 rotates, the first magnet 121 supported by the housing 170 may rotate. As the first magnet 121 rotates, the second magnet 122 and the yoke 123 may rotate by the magnetic force of the first magnet 121 and the second magnet 122. As the second magnet 122 and the yoke 123 rotate, the shaft 130 coupled to the second magnet 122 and the yoke 123 may rotate. As the shaft 130 rotates, the valve holder 530 supporting the shaft 130 may rotate. As the valve holder 530 rotates, the valve 520 supported by the valve holder 530 may rotate. That is, the housing 170, the first magnet 121, the second magnet 122, the yoke 123, the shaft 130, the valve holder 530, and the valve 520 may rotate due to the power transmission portion 20. At this time, the rotational direction and rotational angular velocity of the above-described components may all be the same.

The shaft support 533 may protrude from the holder base 531. Particularly, the shaft support 533 may protrude from the other surface of the holder base 531. For example, the shaft support 533 may protrude from approximately the center of the holder base 531.

The shaft support 533 may be provided on an inner side of the holder body 532. Particularly, a hollow space may be formed on the inner side of the holder body 532, and the shaft support 533 may be provided within the hollow space.

According to some embodiments of the present disclosure, the first cover unit 500 may further include a sealing member (e.g., a seal) surrounding an outer surface of the valve holder 530. In this case, the sealing member may prevent the refrigerant introduced through the first inlet port P1 and the refrigerant discharged through the first outlet port P3 from mixing with each other.

The first cover unit 500 may include a contact plate 540. The contact plate 540 may be disposed between the first base plate 510 and the valve 520.

The contact plate 540 may include stainless steel. In this case, a sealing strength between the valve 520 and the contact plate 540, which may include the PPS material, may be further improved. Accordingly, the leakage of refrigerant between the valve 520 and the contact plate 540 may be prevented. However, the material of the contact plate 540 is not limited thereto.

The contact plate 540 may include a first plate hole 541. The first plate hole 541 may be provided to allow one end of the shaft 130 to penetrate therethrough. The first plate hole 541 may be formed approximately at a center of the first base plate 510.

The contact plate 540 may include a second plate hole 542. The second plate hole 542 may communicate with the first port insertion hole 512. In other words, the second plate hole 542 may be connected to the first port insertion hole 512.

A plurality of second plate holes 542 may be provided. The plurality of second plate holes 542 may be arranged in a circle around the first plate hole 541. Particularly, the plurality of second plate holes 542 may be arranged along a direction in which the plurality of first port insertion holes 512 is arranged. Each of the plurality of second plate holes 542 may be formed at a position corresponding to each of the plurality of first port insertion holes 512.

Additionally, the contact plate 540 may be omitted. In this case, the first base plate 510 and the valve 520 may be in surface contact with each other.

The first cover unit 500 may include an elastic member 550. The elastic member 550 may be positioned between the first case 560 and the valve holder 530, which will be described below. With the configuration, the elastic member 550 may press the valve holder 530 toward the valve 520, and the adhesion between the valve 520 and the contact plate 540 may be further improved. Accordingly, the leakage of refrigerant between the valve 520 and the contact plate 540 may be more effectively prevented.

The first cover unit 500 may include the first case 560. The first case 560 may cover one side of the first base plate 510. In other words, the first case 560 may cover the valve 520. In other words, the first case 560 may cover the valve holder 530. In other words, the first case 560 may cover one side of the first bracket 200.

The first case 560 may be provided on one side of the first base plate 510. The first case 560 may be coupled to one side of the first base plate 510.

The first case 560 may be provided to receive various components of the first cover unit 500 described above. In other words, various components of the first cover unit 500 may be provided on an inner side of the first case 560.

For example, the first case 560 may be provided to receive the valve 520, the valve holder 530, the contact plate 540, and the elastic member 550. In other words, the valve 520, the valve holder 530, the contact plate 540, and the elastic member 550 may be provided on the inner side of the first case 560.

The first case 560 may include a first case inlet 561. The first case inlet 561 may be provided to allow the refrigerant to flow into an inside of the first case 560.

The first case inlet 561 may be connected to the fourth pipe 4d. Accordingly, a refrigerant, which exchanges heat with the first heat exchanger 1a, may sequentially pass through the fourth pipe 4d and the first case inlet 561, and flow into the inside of the first case 560 (refer to FIG. 1).

The refrigerant introduced into the first case 560 through the first case inlet 561 may flow into the first inlet port P1. This will be described in detail below.

The first case 560 may include a first case outlet 562. The first case outlet 562 may be provided to discharge a refrigerant from the first case 560.

The first case outlet 562 may be connected to the first pipe 4a. Accordingly, the refrigerant discharged from the first case 560 may sequentially pass through the first case outlet 562 and the first pipe 4a, and flow toward the first heat exchanger 1a.

The refrigerant introduced into the first case 560 through the first outlet port P3 may be discharged from the first case 560 through the first case outlet 562. This will be described in detail below.

The first cover unit 500 may include a first cover sealing member 570 (e.g., a first cover seal). The first cover sealing member 570 may be disposed between the first base plate 510 and the first case 560. That is, the first cover sealing member 570 may seal between the first base plate 510 and the first case 560.

The first cover sealing member 570 may be formed in a substantially ring shape. However, there is no particular limitation on the shape of the first cover sealing member 570.

The second cover unit 600 may include a second base plate 610. The second base plate 610 may be provided on one side of the second bracket 300. The second base plate 610 may be coupled to one side of the second bracket 300.

The second base plate 610 may include a fourth shaft insertion hole 611. The fourth shaft insertion hole 611 may be provided to allow the other end of the shaft 130 to be inserted thereinto. The fourth shaft insertion hole 611 may be formed approximately in a center of the second base plate 610.

The second base plate 610 may include the second port insertion hole 612. The second port insertion hole 612 may be provided to allow the port P to be inserted thereinto. Particularly, the second port insertion hole 612 may be provided to allow the second inlet port P2 or the second outlet port P4 to be inserted thereinto.

A plurality of second port insertion holes 612 may be provided. The plurality of second inlet ports P2 may be inserted into some of the plurality of second port insertion holes 612, and the plurality of second outlet ports P4 may be inserted into others of the plurality of second port insertion holes 612.

The plurality of second port insertion holes 612 may be arranged in a circle around the fourth shaft insertion hole 611. Particularly, some of the plurality of second port insertion holes 612 may be arranged along the direction in which the plurality of second inlet ports P2 is arranged, and others of the plurality of second port insertion holes 612 may be arranged along the direction in which the plurality of second outlet ports P4 is arranged.

The second cover unit 600 may include a check valve 620. The check valve 620 may control the refrigerant, which is passing through the plurality of ports P, to flow in only one direction. Particularly, the check valve 620 may control the refrigerant, which is passing through the ports P provided on the other side of the magnetic regeneration portion 110 among the plurality of ports P, to flow in only one direction. The check valve 620 may be inserted into the second port insertion hole 612.

For example, the check valve 620 may control the refrigerant passing through the plurality of second inlet ports P2 to flow in only one direction. That is, the check valve 620 may control the refrigerant to allow the refrigerant to flow into the magnetic regeneration portion 110 through the second inlet port P2, but to block the refrigerant from being discharged from the magnetic regeneration portion 110 through the second inlet port P2.

For example, the check valve 620 may control the refrigerant passing through the plurality of second outlet ports P4 to flow in only one direction. That is, the check valve 620 may control the refrigerant to allow the refrigerant to be discharged from the magnetic regeneration portion 110 through the second outlet port P4, but to block the refrigerant from flowing into the magnetic regeneration portion 110 through the second outlet port P4.

A plurality of check valves 620 may be provided. Each of the plurality of check valves 620 may be inserted into the plurality of second port insertion holes 612.

The second cover unit 600 may include the second case 630. The second case 630 may cover one side of the second base plate 610. In other words, the second case 630 may cover one side of the second bracket 300.

The second case 630 may be provided on one side of the second base plate 610. The second case 630 may be coupled to one side of the second base plate 610.

The second case 630 may include a second case inlet 631. The second case inlet 631 may be provided to allow the refrigerant to flow into an inside of the second case 630.

The second case inlet 631 may be connected to the third pipe 4c. Accordingly, the refrigerant, which exchanges heat with the second heat exchanger 1b, may sequentially pass through the third pipe 4c and the second case inlet 631 and flow into the inside of the second case 630 (refer to FIG. 1).

As described above, the second inlet port P2 may be provided to allow the refrigerant inside the second case 630 to flow therein. That is, the refrigerant flowing into the second case 630 through the second case inlet 631 may flow into the second inlet port P2.

The second case 630 may include a second case outlet 632. The second case outlet 632 may be provided to discharge the refrigerant from the second case 630.

The second case outlet 632 may be connected to the second pipe 4b. Accordingly, the refrigerant discharged from the second case 630 may sequentially pass through the second case outlet 632 and the second pipe 4b and flow toward the second heat exchanger 1b.

As described above, the second outlet port P4 may be provided to discharge the refrigerant into the second case 630. That is, the refrigerant flowing into the second case 630 through the second outlet port P4 may be discharged from the second case 630 through the second case outlet 632.

The second cover unit 600 may include a second cover sealing member 640 (e.g., a second cover seal). The second cover sealing member 640 may be disposed between the second base plate 610 and the second case 630. That is, the second cover sealing member 640 may seal between the second base plate 610 and the second case 630.

The second cover sealing member 640 may be provided in a substantially ring shape. However, there is no particular limitation on the shape of the second cover sealing member 640. A plurality of second cover sealing members 640 may be provided.

FIG. 9 is a cross-sectional view illustrating a state in which a heating flow path is formed inside a magnetic regeneration pipe according to an embodiment. FIG. 10 is a cross-sectional view illustrating a state in which a cooling flow path is formed inside the magnetic regeneration pipe according to an embodiment.

Referring to FIGS. 9 and 10, the magnetic regeneration pipe 111 may form a receiving space S. The receiving space S may be provided inside the magnetic regeneration pipe 111.

The magnetic regeneration pipe 111 may include a first inlet pipe 111a. The first inlet pipe 111a may connect the first inlet port P1 and the receiving space S. That is, the first inlet port P1 and the receiving space S may communicate through the first inlet pipe 111a. Accordingly, the refrigerant introduced through the first inlet port P1 may pass through the first inlet pipe 111a and flow into the receiving space S.

The magnetic regeneration pipe 111 may include a second inlet pipe 111b. The second inlet pipe 111b may connect the second inlet port P2 and the receiving space S. That is, the second inlet port P2 and the receiving space S may communicate through the second inlet pipe 111b. Accordingly, the refrigerant introduced through the second inlet port P2 may pass through the second inlet pipe 111b and flow into the receiving space S.

The magnetic regeneration pipe 111 may include a first outlet pipe 111c. The first outlet pipe 111c may connect the first outlet port P3 and the receiving space S. That is, the first outlet port P3 and the receiving space S may communicate through the first outlet pipe 111c. Accordingly, the refrigerant within the receiving space S may pass through the first outlet pipe 111c and be discharged through the first outlet port P3.

The magnetic regeneration pipe 111 may include a second outlet pipe 111d. The second outlet pipe 111d may connect the second outlet port P4 and the receiving space S. That is, the second outlet port P4 and the receiving space S may communicate through the second outlet pipe 111d. Accordingly, the refrigerant within the receiving space S may pass through the second outlet pipe 111d and be discharged through the second outlet port P4.

According to some embodiments of the present disclosure, the magnetic regeneration pipe 111 may include a diffuser. The diffuser may be installed in the first inlet port P1 or the second inlet port P2. The diffuser may be configured to uniformly spray the refrigerant, which is introduced through the first inlet port P1 or the second inlet port P2, into the receiving space S.

The magnetocaloric material M may be received in the receiving space S. The magnetocaloric material M may be a magnetic substance in which a temperature changes during magnetization and demagnetization processes through the magnetocaloric effect. The magnetocaloric effect refers to the effect in which, in response to a magnetic field being applied to the magnetic substance, the magnetic moments within the magnetic substance align in the direction of the magnetic field and the temperature of the magnetic substance changes.

For example, a temperature of the magnetocaloric material M may increase during the magnetization process. For example, the temperature of the magnetocaloric material M may decrease during the demagnetization process. The temperature change process described above may occur within a very short period of time.

According to the embodiment, the magnetocaloric material M may repeat magnetization and demagnetization as the at least one magnet 120 rotates. For example, when a magnetic field is formed in the magnetic regeneration pipe 111 by the at least one magnet 120, the temperature of the magnetocaloric material M may increase. For example, when the at least one magnet 120 rotates and the magnetic field formed in the magnetic regeneration pipe 111 disappears, the temperature of the magnetocaloric material M may decrease.

In addition, the magnetocaloric material M may have different reaction temperatures depending on the characteristics of the material. In other words, the magnetocaloric material M may have different Curie temperatures depending on the characteristics of the material. For example, while any first magnetocaloric material may react only at a temperature around 20 degrees (e.g., 20 degrees Celsius) to cause a temperature change, any second magnetocaloric material may react only at a temperature around 5 degrees (e.g., 5 degrees Celsius) to cause a temperature change. In this case, the first magnetocaloric material may not cause a temperature change at a temperature around 5 degrees (e.g., 5 degrees Celsius), and the second magnetocaloric material may not cause a temperature change at a temperature around 20 degrees (e.g., 20 degrees Celsius).

For example, the magnetocaloric material M may be composed of an iron-based alloy to which rare earth elements such as gadolinium (Gd), lanthanum (La), or neodymium (Nd) are added. However, the types of magnetocaloric materials M are not limited thereto.

The receiving space S may be provided to allow a refrigerant to flow. The refrigerant may exchange heat with the magnetocaloric material M while flowing through the receiving space S. At this time, the refrigerant may be heated due to a temperature increase of the magnetocaloric material M or cooled due to a temperature decrease of the magnetocaloric material M. Accordingly, either a heating flow path F1 for heating the refrigerant or a cooling flow path F2 for cooling the refrigerant may be formed inside the magnetic regeneration pipe 111.

Referring to FIG. 9, a magnetic field may be formed in the magnetic regeneration pipe 111 by the at least one magnet 120. Accordingly, the magnetocaloric material M may be magnetized and a temperature thereof may increase. In this case, the heating flow path F1 may be formed inside the magnetic regeneration pipe 111. The heating flow path F1 may extend from the second inlet port P2 toward the first outlet port P3. The refrigerant flowing along the heating flow path F1 may absorb heat from the magnetocaloric material M and be heated. Accordingly, the temperature of the refrigerant may increase.

Referring to FIG. 10, the magnetic field formed in the magnetic regeneration pipe 111 may disappear. Accordingly, the magnetocaloric material M may be demagnetized and the temperature may decrease. In this case, the cooling flow path F2 may be formed inside the magnetic regeneration pipe 111. The cooling flow path F2 may extend from the first inlet port P1 toward the second outlet port P4. The refrigerant flowing along the cooling flow path F2 may be cooled by releasing heat to the magnetocaloric material M. Accordingly, the temperature of the refrigerant may decrease.

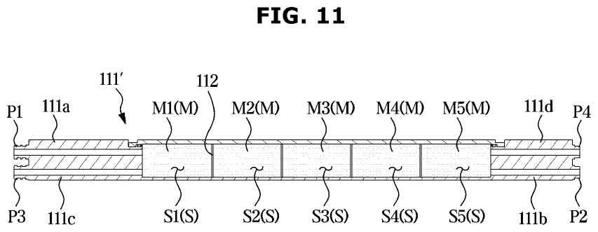

FIG. 11 is a cross-sectional view of a magnetic regeneration pipe according to an embodiment.

Hereinafter a magnetic regeneration pipe 111′ according to an embodiment of the present disclosure will be described with reference to FIG. 11. In describing the magnetic regeneration pipe 111′, components that are substantially the same as those illustrated in FIGS. 1 to 10 are assigned the same reference numerals, and a repeated description thereof may be omitted.

Referring to FIG. 11, the magnetic regeneration pipe 111′ may include a magnetocaloric material M received in a receiving space S. Particularly, the magnetocaloric material M may be provided in the form of a plurality of particles.

The magnetic regeneration pipe 111′ may include a mesh net 112. The mesh net 112 may be provided to allow a refrigerant to pass therethrough. Accordingly, the refrigerant within the magnetic regeneration pipe 111′ may flow while passing through both the magnetocaloric material M and a plurality of mesh nets 112.

A plurality of mesh nets 112 may be provided. The plurality of mesh nets 112 may divide the receiving space S into a plurality of spaces.

For example, four mesh nets 112 may partition the receiving space S into five spaces. Particularly, the four mesh nets 112 may partition the receiving space S into a first space S1, a second space S2, a third space S3, a fourth space S4, and a fifth space S5. At this time, the first space S1, the second space S2, the third space S3, the fourth space S4, and the fifth space S5 may be sequentially positioned along a direction in which the magnetic regeneration pipe 111′ extends.

However, the number of mesh nets 112 or the number of spaces partitioned by the mesh nets 112 are not limited thereto. For example, a single mesh net 112 may be provided, and the receiving space S2 may be partitioned into only two spaces in total. However, the following description will be focused on an embodiment in which four mesh nets 112 partition the receiving space S into five spaces.

The magnetocaloric material M may be received each space defined by the mesh net 112. For example, a first magnetocaloric material M1 may be received in the first space S1, a second magnetocaloric material M2 may be received in the second space S2, a third magnetocaloric material M3 may be received in the third space S3, a fourth magnetocaloric material M4 may be received in the fourth space S4, and a fifth magnetocaloric material M5 may be received in the fifth space S5.

At this time, a Curie temperature of the magnetocaloric material M may differ depending on the space partitioned by the mesh net 112. Particularly, a Curie temperature of the magnetocaloric material M provided in each space may increase from a space close to the second inlet port P2 to a space close to the first outlet port P3. For example, a Curie temperature of the fifth magnetocaloric material M5 provided in the fifth space S5 close to the second inlet port P2 may be 5 degrees (e.g., 5 degrees Celsius), a Curie temperature of the fourth magnetocaloric material M4 provided in the fourth space S4 may be 10 degrees (e.g., 10 degrees Celsius), a Curie temperature of the third magnetocaloric material M3 provided in the third space S3 may be 15 degrees (e.g., 15 degrees Celsius), a Curie temperature of the second magnetocaloric material M2 provided in the second space S2 may be 20 degrees (e.g., 20 degrees Celsius), and a Curie temperature of the first magnetocaloric material M1 provided in the first space S1 close to the first outlet port P3 may be 25 degrees (e.g., 25 degrees Celsius).

With the above-described configuration, a temperature of the refrigerant passing through the magnetic regeneration pipe 111 may gradually increase or decrease. For example, a temperature of the refrigerant flowing along the heating flow path F1 (refer to FIG. 9) may gradually increase by sequentially passing from the fifth magnetocaloric material M5 having the lowest Curie temperature to the first magnetocaloric material M1 having the highest Curie temperature. For example, a temperature of the refrigerant flowing along the cooling flow path F2 (refer to FIG. 10) may gradually decrease by sequentially passing from the first magnetocaloric material M1 having the highest Curie temperature to the fifth magnetocaloric material M5 having the lowest Curie temperature. At this time, a temperature of the magnetocaloric material M provided in each space may have a temperature similar to the respective Curie temperature by continuously exchanging heat with the refrigerant passing through the magnetic regeneration pipe 111′.

When only a single type of magnetocaloric material is received within a magnetic refrigerant pipe, a temperature change range of the magnetocaloric material may be more limited. For example, when the Curie temperature of the magnetocaloric material is 20 degrees (e.g., 20 degrees Celsius), it may be more difficult to sufficiently heat or cool the refrigerant through the magnetic refrigerant pipe because the temperature change range of the magnetocaloric material is limited to around 20 degrees (e.g., 20 degrees Celsius).

According to some embodiments of the present disclosure, by partitioning the receiving space S into the plurality of spaces and providing magnetocaloric materials M having different Curie temperatures within each space, the heating and cooling range of the magnetic regeneration pipe 111′ may be further improved. Accordingly, the performance of the cooling apparatus 2 (refer to FIG. 2) may be further enhanced.

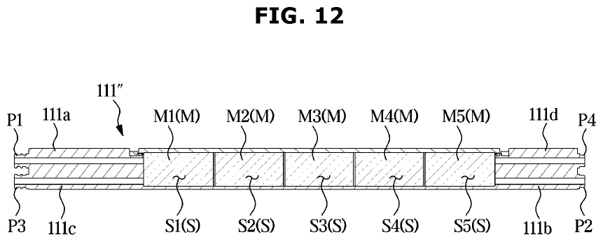

FIG. 12 is a cross-sectional view of a magnetic regeneration pipe according to an embodiment.

Hereinafter a magnetic regeneration pipe 111″ according to an embodiment of the present disclosure will be described with reference to FIG. 12. In describing the magnetic regeneration pipe 111″, components that are substantially the same as those illustrated in FIGS. 1 to 10 are assigned the same reference numerals, and a repeated description thereof may be omitted.

Referring to FIG. 12, the magnetic regeneration pipe 111″ may include a magnetocaloric material M received in a receiving space S. Particularly, the magnetocaloric material M may be formed in a block shape. For example, the block may be manufactured using a three-dimensional (3D) printing method using the magnetocaloric material M.

A plurality of microchannels, through which a refrigerant may pass, may be provided within the block. Accordingly, the refrigerant within the magnetic regeneration pipe 111″ may flow while passing through the block-shaped magnetocaloric material M.

A plurality of blocks may be provided. The plurality of blocks may be arranged along a direction in which the magnetic regeneration pipe 111″ extends. For example, five blocks may be arranged along the direction in which the magnetic regeneration pipe 111″ extends.

However, the number of blocks is not limited here. For example, four or less of blocks may be provided or six or more of blocks may be provided. However, the following description will be focused on an embodiment in which five blocks are provided.

The magnetocaloric material M forming each of the plurality of blocks may have different Curie temperatures. Particularly, a Curie temperature of the magnetocaloric material M may increase from a block close to the second inlet port P2 to a block close to the first outlet port P3. Because this has already been described with reference to FIG. 11, a repeated description thereof will be omitted.

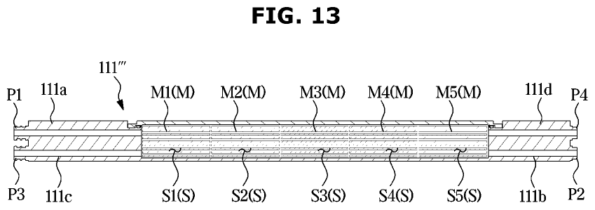

FIG. 13 is a cross-sectional view of a magnetic regeneration pipe according to an embodiment.

Hereinafter a magnetic regeneration pipe 111′″ according to an embodiment of the present disclosure will be described with reference to FIG. 13. In describing the magnetic regeneration pipe 111′″, components that are substantially the same as those illustrated in FIGS. 1 to 10 are assigned the same reference numerals, and a repeated description thereof may be omitted.

Referring to FIG. 13, the magnetic regeneration pipe 111′″ may include a magnetocaloric material M received in a receiving space S. Particularly, the magnetocaloric material M may be formed in a plate shape.

A plurality of plates may be provided. The plurality of plates may be stacked. For example, the plurality of plates may be stacked in the up and down direction. For example, the plurality of plates may be stacked in the left and right direction. A structure, in which the plurality of plates is stacked, may be referred to as a plate unit.

A fine gap may be formed between adjacent plates. Therefore, the refrigerant within the magnetic regeneration pipe 111′″ may flow through the gap between plates adjacent thereto.

A plurality of plate units may be provided. The plurality of plate units may be arranged along a direction in which the magnetic regeneration pipe 111′″ extends. For example, five plate units may be arranged along the direction in which the magnetic regeneration pipe 111′″ extends.

However, the number of plate units is not limited thereto. For example, four or less of plate units may be provided or six or more of plate units may be provided. However, an embodiment in which five plate units are provided will be described below.

The magnetocaloric material M forming each of the plurality of plate units may have different Curie temperatures. Particularly, a Curie temperature of the magnetocaloric material M may increase from a plate unit close to the second inlet port P2 to a plate unit close to the first outlet port P3. Because this has already been described with reference to FIG. 11, a repeated description thereof will be omitted.

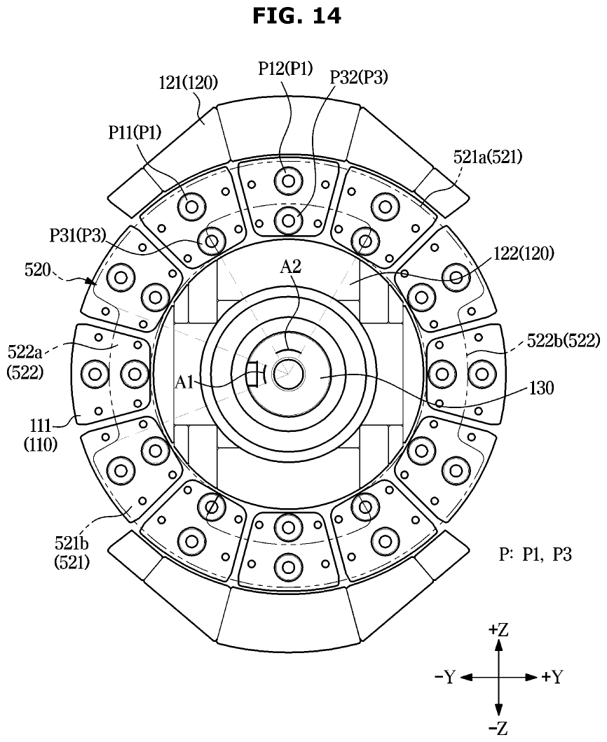

In the above, the magnetic regeneration pipes 111′, 111″, and 111′″ according to an embodiment of the present disclosure are described with reference to FIGS. 11 to 13. Hereinafter, the cooling apparatus 2 according to an embodiment of the present disclosure will be described again with reference to FIGS. 14 to 18.

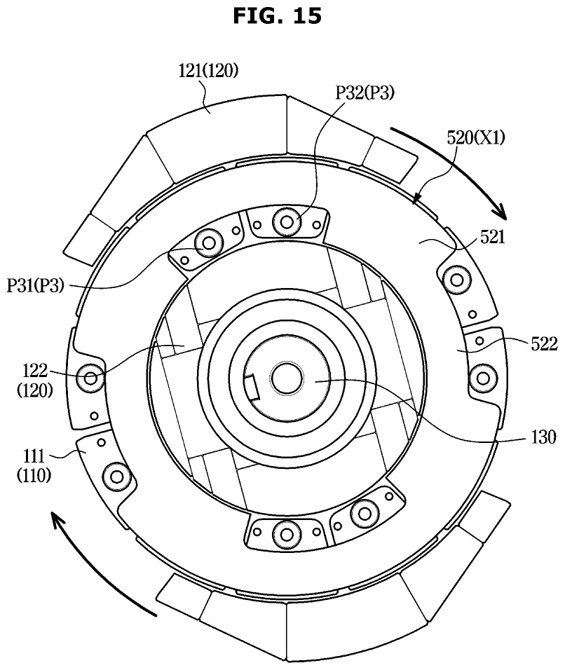

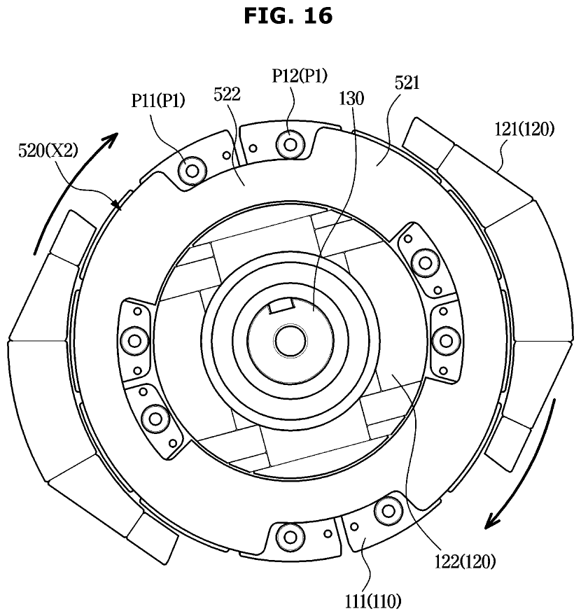

FIG. 14 is a view illustrating a plurality of magnetic regeneration pipes and a rotary valve according to an embodiment. FIG. 15 is a view illustrating a state in which the rotary valve according to an embodiment is in a first position. FIG. 16 is a view illustrating a state in which the rotary valve according to an embodiment is in a second position.

The valve 520 may be configured to rotate. For example, based on FIGS. 15 and 16, the valve 520 may rotate clockwise or counterclockwise. In the description, an embodiment in which the valve 520 rotates clockwise (refer to FIGS. 15 and 16) will be described.

The valve 520 may be configured to open and close the plurality of ports P based on the rotation of the valve 520. That is, each of the plurality of ports P may be opened or closed by a single valve 520.

With the configuration, the cooling apparatus 2 (refer to FIG. 2) may have a relatively small volume. For example, the cooling apparatus 2 according to an embodiment of the present disclosure may have a smaller volume than a volume of a cooling apparatus having a solenoid valve installed in each of a plurality of ports P to open and close each of the plurality of ports P.

In addition, the valve 520 may not include a separate device for instantaneously opening or closing each of the plurality of ports P. Therefore, noise that may occur during the operation of the cooling apparatus 2 may be reduced. For example, because a solenoid valve drives a plunger to open or close a port based on an electric signal, a striking noise may occur between the plunger and another structure. However, the cooling apparatus 2 may open and close the plurality of ports P only by the rotation of the valve 520 and thus noise such as a striking noise may be reduced.

The valve 520 may include valve covers (e.g., the inlet valve cover 521 and the outlet valve cover 522). The valve covers (e.g., the inlet valve cover 521 and the outlet valve cover 522) may be configured to open or close some ports P, which are adjacent to each other among the plurality of ports P, based on the rotation of the valve 520. For example, the valve covers (e.g., the inlet valve cover 521 and the outlet valve cover 522) may open two ports P adjacent to each other, may open only one of the two ports P, or may close both of the two ports P.

The valve covers (e.g., the inlet valve cover 521 and the outlet valve cover 522) may extend along the circumferential direction of the shaft 130. In other words, the valve covers (e.g., the inlet valve cover 521 and the outlet valve cover 522) may extend along the direction in which the plurality of magnetic regeneration pipes 111 is arranged.

The valve covers (e.g., the inlet valve cover 521 and the outlet valve cover 522) may include an inlet valve cover 521. The inlet valve cover 521 may be configured to open or close some first inlet ports P1, which are adjacent to each other among the plurality of first inlet ports P1, based on the rotation of the valve 520.

The valve covers may include an outlet valve cover 522. The outlet valve cover 522 may be configured to open or close some first outlet ports P3, which are adjacent to each other among the plurality of first outlet ports P3, based on the rotation of the valve 520.

The inlet valve cover 521 may be provided at a position corresponding to the plurality of first inlet ports P1. For example, the inlet valve cover 521 may be configured to overlap with the plurality of first inlet ports P1 in the X direction. The outlet valve cover 522 may be provided at a position corresponding to the plurality of first outlet ports P3. For example, the outlet valve cover 522 may be configured to overlap with the plurality of first outlet ports P3 in the X direction.

The first inlet port P1 may be more outward than the first outlet port P3, and the inlet valve cover 521 may be more outward than the outlet valve cover 522. In other words, the outlet valve cover 522 may be provided more inward than the inlet valve cover 521.

However, as described above, the first inlet port P1 may be more inward than the first outlet port P3. In this case, the inlet valve cover 521 may be more inward than the outlet valve cover 522.

The inlet valve cover 521 may extend along the circumferential direction of the shaft 130. In other words, the inlet valve cover 521 may extend along the direction in which the plurality of magnetic regeneration pipes 111 is arranged. For example, the inlet valve cover 521 may be provided in an arc shape.

The outlet valve cover 522 may extend along the circumferential direction of the shaft 130. In other words, the outlet valve cover 522 may extend along the direction in which the plurality of magnetic regeneration pipes 111 is arranged. For example, the outlet valve cover 522 may be provided in an arc shape.

A plurality of inlet valve covers 521 may be provided. The plurality of inlet valve covers 521 may be arranged to be spaced apart from each other along the circumferential direction of the shaft 130. In other words, the plurality of inlet valve covers 521 may be arranged to be spaced apart from each other along the direction in which the plurality of magnetic regeneration pipes 111 is arranged.

A plurality of outlet valve covers 522 may be provided. The plurality of outlet valve covers 522 may be arranged to be spaced apart from each other along the circumferential direction of the shaft 130. In other words, the plurality of outlet valve covers 522 may be arranged to be spaced apart from each other along the direction in which the plurality of magnetic regeneration pipes 111 is arranged.

For example, the inlet valve cover 521 may include a first inlet valve cover 521a and a second inlet valve cover 521b. The first inlet valve cover 521a and the second inlet valve cover 521b may be spaced apart from each other along the circumferential direction of the shaft 130. In other words, the first inlet valve cover 521a and the second inlet valve cover 521b may be spaced apart from each other along the direction in which the plurality of magnetic regeneration pipes 111 is arranged.

In addition, the first inlet valve cover 521a and the second inlet valve cover 521b may be provided on opposite sides of the shaft 130. In other words, the first inlet valve cover 521a and the second inlet valve cover 521b may be arranged to have a phase difference of 180 degrees with respect to the shaft 130.

For example, the outlet valve cover 522 may include a first outlet valve cover 522a and a second outlet valve cover 522b. The first outlet valve cover 522a and the second outlet valve cover 522b may be spaced apart from each other along the circumferential direction of the shaft 130. In other words, the first outlet valve cover 522a and the second outlet valve cover 522b may be spaced apart from each other along the direction in which the plurality of magnetic regeneration pipes 111 is arranged.

In addition, the first outlet valve cover 522a and the second outlet valve cover 522b may be provided on opposite sides of the shaft 130. In other words, the first outlet valve cover 522a and the second outlet valve cover 522b may be arranged to have a phase difference of 180 degrees with respect to the shaft 130.

The plurality of inlet valve covers 521 and the plurality of outlet valve covers 522 may be arranged alternately along the circumferential direction of the shaft 130. In other words, the plurality of inlet valve covers 521 and the plurality of outlet valve covers 522 may be arranged alternately along the direction in which the plurality of magnetic regeneration pipes 111 is arranged.

For example, each of the first inlet valve cover 521a and the second inlet valve cover 521b may be disposed between the first outlet valve cover 522a and the second outlet valve cover 522b with respect to the circumferential direction of the shaft 130. For example, each of the first outlet valve cover 522a and the second outlet valve cover 522b may be disposed between the first inlet valve cover 521a and the second inlet valve cover 521b with respect to the circumferential direction of the shaft 130.

However, the number of each of the inlet valve covers 521 and the outlet valve covers 522 is not limited to the above-described embodiment. For example, each of the inlet valve covers 521 and the outlet valve covers 522 may be provided as one, or as three or more.

Hereinafter an opening and closing method of the first inlet port P1 and the first outlet port P3 according to the rotation of the valve 520 will be described in more detail with reference to FIGS. 14 to 16.

Referring to FIGS. 14 and 15, the plurality of first inlet ports P1 may include a first port P11 and a second port P12 that are spaced apart from each other along the circumferential direction of the shaft 130. The first port P11 and the second port P12 may be adjacent to each other. The first port P11 and the second port P12 may be arranged along the circumferential direction of the shaft 130, at a same distance from the shaft 130 in radial directions of the shaft 130. In other words, the first port P11 and the second port P12 may be arranged along the direction in which the plurality of magnetic regeneration pipes 111 is arranged, at a same distance from the shaft 130 in radial direction of the shaft 130.

The plurality of first outlet ports P3 may include a third port P31 and a fourth port P32 that are spaced apart from each other along the circumferential direction of the shaft 130. The third port P31 and the fourth port P32 may be adjacent to each other. The third port P31 and the fourth port P32 may be arranged along the circumferential direction of the shaft 130, at a same distance from the shaft 130 in radial directions of the shaft 130. In other words, the third port P31 and the fourth port P32 may be arranged along the direction in which the plurality of magnetic regeneration pipes 111 is arranged, at a same distance from the shaft 130 in radial directions of the shaft 130.

The first port P11 and the third port P31 may be provided in the same magnetic regeneration pipe 111 among the plurality of magnetic regeneration pipes 111. Accordingly, the first port P11 and the third port P31 may be arranged with respect to each other along a same radial direction of the shaft 130.

The second port P12 and the fourth port P32 may be provided in the same magnetic regeneration pipe 111 among the plurality of magnetic regeneration pipes 111. Accordingly, the second port P12 and the fourth port P32 may be arranged with respect to each other along a same radial direction of the shaft 130.

The valve 520 may be positioned at a first position X1 such as to open both the third port P31 and the fourth port P32. At this time, both the first port P11 and the second port P12 may be closed. That is, in response to the valve 520 being at the first position X1, the outlet valve cover 522 may open both the third port P31 and the fourth port P32, and the inlet valve cover 521 may close both the first port P11 and the second port P12.

Each of the first magnet 121 and the second magnet 122 may be positioned to correspond to an area opened by the outlet valve cover 522. Particularly, each of the first magnet 121 and the second magnet 122 may be positioned in such a way that the first magnet 121, the area opened by the outlet valve cover 522, and the second magnet 122 are sequentially arranged along the radial direction of the shaft 130.

For example, in response to the valve 520 being at the first position X1, each of the first magnet 121 and the second magnet 122 may be positioned to correspond to the first outlet ports P3 opened by the outlet valve cover 522 among the plurality of first outlet ports P3. Particularly, each of the first magnet 121 and the second magnet 122 may be positioned in such a way that the first magnet 121, the first outlet ports P3 opened by the outlet valve cover 522 among the plurality of first outlet ports P3, and the second magnet 122 are sequentially arranged along the radial direction of the shaft 130.

The heating flow path F1 (refer to FIG. 9) by the magnetic calorific effect may be formed within the magnetic regeneration pipe 111 located in the area opened by the outlet valve cover 522. At this time, the first outlet port P3 of the magnetic regeneration pipe 111 located in the area opened by the outlet valve cover 522 may be opened, and thus the refrigerant flowing along the heating flow path F1 (refer to FIG. 9) within the magnetic regeneration pipe 111 may be discharged through the first outlet port P3. For example, the refrigerant flowing along the heating flow path F1 within the magnetic regeneration pipe 111 may be discharged through the third port P31 and the fourth port P32.

In addition, in response to the first outlet port P3 being opened by the outlet valve cover 522, the first inlet port P1 arranged from the first outlet port P3 along the radial direction of the shaft 130 may be closed. That is, in one magnetic regeneration pipe 111, in response to the first outlet port P3 being opened, the first inlet port P1 may be closed. For example, in response to both the third port P31 and the fourth port P32 being opened, both the first port P11 and the second port P12 may be closed.

Accordingly, in one magnetic regeneration pipe 111, in response to the first outlet port P3 being opened and the refrigerant being discharged, the first inlet port P1 may be closed and the refrigerant may not pass therethrough. For example, in response to both the third port P31 and the fourth port P32 being opened and the refrigerant being discharged, both the first port P11 and the second port P22 may be closed and the refrigerant may not pass therethrough. With the configuration, in response to the refrigerant being discharged through the first outlet port P3, the refrigerant may be prevented from being introduced or discharged through the first inlet port P1.

Referring to FIGS. 14 and 16, the valve 520 may be positioned at a second position X2 such as to open both the first port P11 and the second port P12. At this time, both the third port P31 and the fourth port P32 may be closed. That is, in response to the valve 520 being at the second position X2, the inlet valve cover 521 may open both the first port P11 and the second port P12, and the outlet valve cover 522 may close both the third port P31 and the fourth port P32.

The cooling flow path F2 (refer to FIG. 10) by the magnetic calorific effect may be formed within the magnetic regeneration pipe 111 located in the area opened by the inlet valve cover 521. At this time, the first inlet port P1 of the magnetic regeneration pipe 111 located in the area opened by the inlet valve cover 521 may be opened, and thus after the refrigerant flows into the magnetic regeneration pipe 111 through the first inlet port P1, the refrigerant may be cooled while flowing along the cooling flow path F2. For example, after flowing into the magnetic regeneration pipe 111 through the first port P11 and the second port P12, the refrigerant may be cooled while flowing along the cooling flow path F2.

In addition, in response to the first inlet port P1 being opened by the inlet valve cover 521, the first outlet port P3 arranged from the first inlet port P1 along the radial direction of the shaft 130 may be closed. That is, in one magnetic regeneration pipe 111, in response to the first inlet port P1 being opened, the first outlet port P3 may be closed. For example, in response to both the first port P11 and the second port P12 being opened, both the third port P31 and the fourth port P32 may be closed.

Therefore, in one magnetic regeneration pipe 111, in response to the first inlet port P1 being opened and the refrigerant being introduced, the first outlet port P3 may be closed and the refrigerant may not pass therethrough. For example, in response to both the first port P11 and the second port P12 being opened and the refrigerant being introduced, both the third port P31 and the fourth port P32 may be closed and the refrigerant may not pass therethrough. With the configuration, it is possible to prevent the refrigerant, which flows into the magnetic regeneration pipe 111 through the first inlet port P1, from being immediately discharged through the first outlet port P3.

Referring to FIGS. 15 and 16, the valve 520 may be positioned at the first position X1, the second position X2, or other positions as the valve 520 rotates. That is, the valve 520 may repeatedly open and close the first inlet port P1 and the first outlet port P3 as the valve 520 rotates.

The at least one magnet 120 may rotate together with the valve 520. Particularly, the first magnet 121 and the second magnet 122 may rotate together with the valve 520.

Accordingly, while the valve 520 rotates, the first outlet ports P3, which are opened by the outlet valve cover 522 among the plurality of first outlet ports P3, may be positioned between the first magnet 121 and the second magnet 122. In addition, while the valve 520 rotates, the first inlet ports P1, which are closed by the inlet valve cover 521 among the plurality of first inlet ports P1, may be positioned between the first magnet 121 and the second magnet 122.

In addition, while the valve 520 rotates, first inlet ports P1 opened by the inlet valve cover 521 among the plurality of first inlet ports P1 may be located outside the area between the first magnet 121 and the second magnet 122. In addition, while the valve 520 rotates, first outlet ports P3 closed by the outlet valve cover 522 among the plurality of first outlet ports P3 may be located outside the area between the first magnet 121 and the second magnet 122.

With the configuration, while the valve 520 rotates, the first outlet port P3 provided in the magnetic regeneration pipe 111, in which the heating flow path F1 (refer to FIG. 9) is formed, and the first inlet port P1 provided in the magnetic regeneration pipe 111, in which the cooling flow path F2 (refer to FIG. 10) is formed, may be always opened. In addition, while the valve 520 rotates, the first inlet port P1 provided in the magnetic regeneration pipe 111, in which the heating flow path F1 is formed, and the first outlet port P3 provided in the magnetic regeneration pipe 111, in which the cooling flow path F2 is formed, may be always closed.

As described above, the at least one magnet 120 may form a magnetic field. That is, the first magnet 121 and the second magnet 122 may form a magnetic field. Accordingly, the refrigerant in the magnetic regeneration pipe 111 located between the first magnet 121 and the second magnet 122 may be heated or cooled by the magnetocaloric effect. At this time, the area between the first magnet 121 and the second magnet 122 may be referred to as a ‘magnetic field area’.

As the at least one magnet 120 rotates, the position of the magnetic field area may continuously change. Accordingly, each of the plurality of magnetic regeneration pipes 111 may repeat the process of being positioned within the magnetic field area to form the heating flow path F1 (refer to FIG. 9) or positioned outside the magnetic field area to form the cooling flow path F2 (refer to FIG. 10).

At this time, the magnetic regeneration pipe 111, which enters the magnetic field area as the at least one magnet 120 rotates, may form the heating flow path F1 (refer to FIG. 9) as the magnetocaloric material M (refer to FIG. 9) is magnetized. However, because a certain amount of time may be required for the magnetocaloric material M to be sufficiently magnetized, it may be difficult for the heating performance of the magnetic regeneration pipe 111 to be fully obtained at the same time as the magnetic regeneration pipe 111 enters the magnetic field area in a comparative embodiment.

According to an embodiment of the present disclosure, the at least one magnet 120 may be provided to allow the magnetic field area to be formed in a size that may cover two or more magnetic regeneration pipes 111 that are adjacent to each other among the plurality of magnetic regeneration pipes 111. For example, the magnetic field area may be provided to be coverable three magnetic regeneration pipes 111 that are adjacent to each other. With the configuration, even when the heating performance is not fully obtained immediately when the magnetic regeneration pipe 111 enters the magnetic field area, the initial delay may be compensated for to a certain extent. This is because, during the rotation process of the valve 520, the magnetic regeneration pipe 111 remains within the magnetic field area for a certain period of time, and thus, 100% of the heating performance may be sufficiently obtained during the certain period of time.

In addition, the magnetic regeneration pipe 111, which deviates from the magnetic field area as the at least one magnet 120 rotates, may form the cooling flow path F2 (refer to FIG. 10) as the magnetocaloric material M (refer to FIG. 10) is demagnetized. Even in this case, because a certain amount of time is required for the magnetocaloric material M to be sufficiently demagnetized, it may be difficult for the cooling performance of the magnetic regeneration pipe 111 to be fully exhibited as soon as the magnetocaloric material M deviates from the magnetic field area in a comparative embodiment.

According to an embodiment of the present disclosure, the at least one magnet 120 may be formed to allow an area outside the magnetic field area to be formed in a size that may cover two or more magnetic regeneration pipes 111 that are adjacent to each other among the plurality of magnetic regeneration pipes 111. For example, the area outside the magnetic field area may be provided to be coverable three magnetic regeneration pipes 111 that are adjacent to each other. With the configuration, even when the cooling performance is not fully exhibited immediately when the magnetic regeneration pipe 111 deviates from the magnetic field area, an initial delay may be compensated for to a certain extent. This is because, during the rotation process of the valve 520, the magnetic regeneration pipe 111 remains in the area outside the magnetic field area for a certain period of time, and thus 100% of the cooling performance may be sufficiently achieved during the certain period of time.

An embodiment has been described in the present disclosure in which a magnetic field area is provided to be coverable three magnetic regeneration pipes 111 that are adjacent to each other and an area outside the magnetic field area is provided to be coverable three magnetic regeneration pipes 111 that are adjacent to each other. However, embodiments of the present disclosure are not limited thereto. For example, an embodiment, in which a magnetic field area is provided to be coverable two magnetic regeneration pipes 111 that are adjacent to each other, and an area outside the magnetic field area is provided to be coverable two magnetic regeneration pipes 111 that are adjacent to each other, may be provided. For example, an embodiment, in which a magnetic field area is provided to be coverable four or more magnetic regeneration pipes 111 that are adjacent to each other, and an area outside the magnetic field area is provided to be coverable four or more magnetic regeneration pipes 111 that are adjacent to each other, may be provided. As the number of magnetic regeneration pipes 111 that may be covered by the magnetic field area or by the area outside the magnetic field area increases, the number of magnetic regeneration pipes 111 that may secure 100% of heating and cooling performance may also increase, and thus the heating and cooling performance of the cooling apparatus 2 may be further improved.

Referring to FIGS. 14 to 16, a first angle A1, at which the plurality of inlet valve covers 521 is spaced apart from each other with respect to the shaft 130, may be 60 degrees or less. For example, the first angle A1, at which the first inlet valve cover 521a and the second inlet valve cover 521b are spaced apart from each other with respect to the shaft 130, may be 60 degrees or less.

Additionally, a second angle A2, at which the plurality of outlet valve covers 522 is spaced apart from each other with respect to the shaft 130, may be 60 degrees or less. For example, the second angle A2, at which the first outlet valve cover 522a and the second outlet valve cover 522b are spaced apart from each other with respect to the shaft 130, may be 60 degrees or less.

With the configuration, at least a portion of the inlet valve cover 521 may overlap with at least a portion of the outlet valve cover 522 with respect to the radial direction of the shaft 130. Particularly, one end of the inlet valve cover 521 may overlap with one end of the outlet valve cover 522 with respect to the radial direction of the shaft 130.

For example, the valve 520 may include an overlapping portion formed by overlapping one end of the inlet valve cover 521 and one end of the outlet valve cover 522. That is, the overlapping portion may include one end of the inlet valve cover 521 and one end of the outlet valve cover 522 that are connected to each other. While the valve 520 rotates, the overlapping portion may be positioned to close both the first inlet port P1 and the first outlet port P3 provided in one of the plurality of magnetic regeneration pipes 111.

Accordingly, it is possible to prevent the first inlet port P1 and the first outlet port P3 provided in one of the plurality of magnetic regeneration pipes 111 from being opened. In other words, it is possible to prevent the first inlet port P1 provided in one of the plurality of magnetic regeneration pipes 111 from being at least partially opened, and the first outlet port P3 provided in the same magnetic regeneration pipe 111 from being at least partially opened. Accordingly, it is possible to prevent the refrigerant from being simultaneously introduced through the first inlet port P1 and the first outlet port P3, or from being simultaneously discharged through the first inlet port P1 and the first outlet port P3.

However, the shape of the valve 520 is not limited to the above-described embodiment. More specific details related to this will be described below.

In addition, the magnetic regeneration portion 110 may include a total of 12 magnetic regeneration pipes 111. In this case, because the magnetic regeneration portion 110 has a structure that is symmetrical in the up and down direction (e.g., Z-axis direction) and left and right direction (e.g., Y-axis direction), the number of each of the first inlet port P1 and the first outlet port P3 opened by the valve 520 may be provided to correspond to each other. With the configuration, the flow rate of the refrigerant passing through the magnetic regeneration portion 110 may be maintained constant, and it may be easier to control the cooling apparatus 2 (refer to FIG. 2).

However, the number of magnetic regeneration pipes 111 is not limited thereto. Particularly, when the number of magnetic regeneration pipes 111 is provided in multiples of 4, the magnetic regeneration portion 110 may include a structure that is symmetrical in the up and down direction (e.g., Z-axis direction) and left and right direction (e.g., Y-axis direction). Even in this case, the flow rate of the refrigerant passing through the magnetic regeneration portion 110 may be maintained constant, and it may be easier to control the cooling apparatus 2 (refer to FIG. 2).

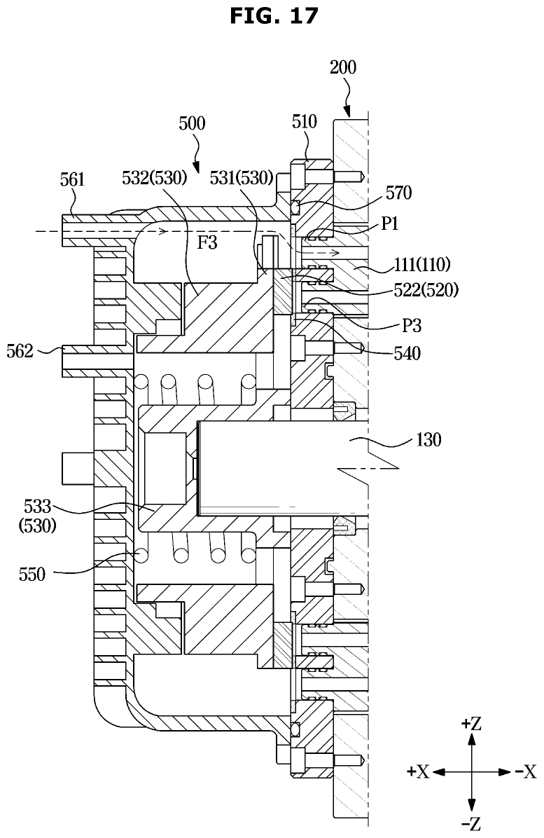

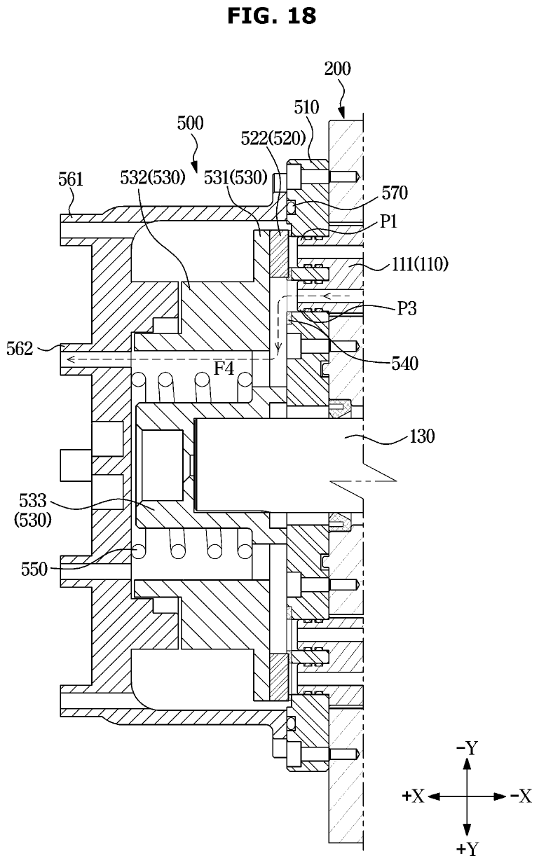

FIG. 17 is an enlarged view of a portion of a cross-section along a line B-B′ shown in FIG. 3. FIG. 18 is an enlarged view of a portion of a cross-section along the line A-A′ shown in FIG. 3.

Referring to FIGS. 17 and 18, the first case 560 may include the first case inlet 561. The first case inlet 561 may be provided to allow the refrigerant to flow into the inside of the first case 560.

The first case inlet 561 may communicate with the first inlet port P1. Particularly, the first case inlet 561 may communicate with the first inlet ports P1 opened by the inlet valve cover 521 among the plurality of first inlet ports P1. With the configuration, the refrigerant within the first case 560 may be introduced into the first inlet port P1.

An inlet flow path F3 extending from the first case inlet 561 to the first inlet port P1 may be formed within the first case 560. Particularly, the inlet flow path F3 may extend from the first case inlet 561 to the first inlet ports P1 opened by the inlet valve cover 521 among the plurality of first inlet ports P1.

The inlet flow path F3 may be formed between the outer surface of the holder body 532 and the inner surface of the first case 560. That is, the refrigerant introduced into the first case 560 through the first case inlet 561 may pass between the outer surface of the holder body 532 and the inner surface of the first case 560 and then flow into the first inlet ports P1 opened by the inlet valve cover 521 among the plurality of first inlet ports P1.

The first case 560 may include the first case outlet 562. The first case outlet 562 may be provided to discharge the refrigerant from the first case 560.

The first case outlet 562 may communicate with the first outlet port P3. Particularly, the first case outlet 562 may communicate with the first outlet ports P3 opened by the outlet valve cover 522 among the plurality of first outlet ports P3. With the configuration, the first outlet port P3 may discharge the refrigerant into the first case 560.

An outlet flow path F4 extending from the first outlet port P to the first case outlet 562 may be formed within the first case 560. Particularly, the outlet flow path F4 may extend from the first outlet ports P3 opened by the outlet valve cover 522 among the plurality of first outlet ports P3 to the first case outlet 562.

The outlet flow path F4 may be formed between the inner surface of the holder body 532 and the outer surface of the shaft support 533. That is, the refrigerant that flows into the first case 560 through the first outlet ports P3 opened by the outlet valve cover 522 among the plurality of first outlet ports P3 may pass between the inner surface of the holder body 532 and the outer surface of the shaft support 533 and then flow into the first case outlet 562.

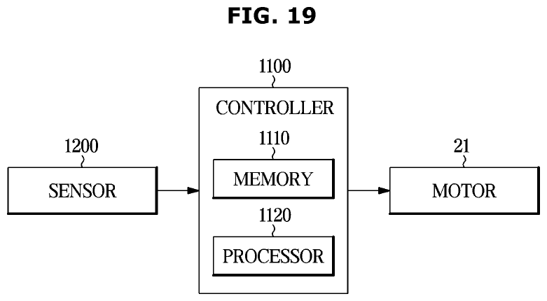

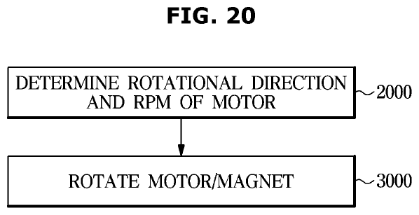

FIG. 19 is a control diagram of the refrigeration cycle device according to an embodiment. FIG. 20 is a flowchart illustrating a control method of the refrigeration cycle device according to an embodiment.

Referring to FIGS. 19 and 20, the refrigeration cycle device R may include a controller 1100. The controller 1100 may include hardware such as a central processing unit (CPU), a Mi-com, a memory, and software such as a control program. For example, the controller 1100 may include at least one memory 1110 provided to store data in the form of an algorithm and a program for controlling the operation of components of the refrigeration cycle device R, and at least one processor 1120 configured to perform the operations described above and operations to be described below using the data stored in the at least one memory 1110.

The at least one memory 1110 and the at least one processor 1120 may be implemented as separate chips. The at least one processor 1120 may include one or more processor chips or one or more processing cores. The at least one memory 1110 may include one or more memory chips or one or more memory blocks. Additionally, the at least one memory 1110 and the at least one processor 1120 may be implemented as a single chip.

The refrigeration cycle device R may further include a sensor 1200. For example, the sensor 1200 may sense a position of the at least one magnet 120 (refer to FIGS. 15 and 16) and transmit information about the position of the at least one magnet 120 to the controller 1100. For example, the sensor 1200 may sense the position of the valve 520 (refer to FIGS. 15 and 16) and transmit information about the position of the valve 520 to the controller 1100.

The refrigeration cycle device R may include the motor 21 of the power transmission portion 20. As the motor 21 rotates the pulley 22, the belt 23 may drive in a specific direction (refer to FIG. 2).

The controller 1100 may control the motor 21. The controller 1100 may control the motor 21 based on the value of the sensor 1200. For example, the controller 1100 may determine the position of the at least one magnet 120 (refer to FIGS. 15 and 16) by controlling the motor 21. For example, the controller 1100 may determine the position of the valve 520 (refer to FIGS. 15 and 16) by controlling the motor 21.

Particularly, the controller 1100 may control a rotational direction and revolution per minute (RPM) of the motor 21. The rotational direction and rotation angular velocity of the housing 170 (refer to FIG. 6) may be determined according to the rotational direction and RPM of the motor 21. At this time, the rotational direction and rotation angular velocity of the housing 170 may be the same as the rotational direction and rotation angular velocity of the first magnet 121 (refer to FIGS. 15 and 16), the second magnet 122 (refer to FIGS. 15 and 16), and the valve 520 (refer to FIGS. 15 and 16).

By the above-described structure and operation manner of the valve 520 (refer to FIGS. 15 and 16), while the valve 520 rotates, the first outlet port P3 (refer to FIGS. 15 and 16) provided in the magnetic regeneration pipe 111 (refer to FIGS. 15 and 16), in which the heating flow path F1 (refer to FIG. 9) is formed, and the first inlet port P1 (refer to FIGS. 15 and 16) provided in the magnetic regeneration pipe 111, in which the cooling flow path F2 (refer to FIG. 10) is formed, may each be always open. In addition, while the valve 520 rotates, the first inlet port P1 provided in the magnetic regeneration pipe 111, in which the heating flow path F1 is formed, and the first outlet port P3 provided in the magnetic regeneration pipe 111, in which the cooling flow path F2 is formed, may each be always closed.

Therefore, the refrigeration cycle device R may not perform separate control for opening or closing the plurality of ports P (refer to FIGS. 15 and 16). In other words, the refrigeration cycle device R may not require a configuration such as a solenoid valve for opening and closing the plurality of ports P. That is, the refrigeration cycle device R may smoothly operate the cooling apparatus 2 only by controlling the rotational direction and RPM of the motor 21 through the controller 1100.

Particularly, the controller 1100 may determine the rotational direction and RPM of the motor 21 (operation 2000). Thereafter, the controller 1100 may rotate the motor 21 (operation 3000). In other words, the controller 1100 may rotate the at least one magnet 120 (operation 3000). Accordingly, the rotation of the valve 520 (refer to FIGS. 15 and 16) may be induced. The valve 520 may open or close some ports P adjacent to each other among the plurality of ports P (refer to FIGS. 15 and 16) based on the rotation of the valve 520.

With the configuration, the cooling apparatus 2 (refer to FIG. 2) may not require separate power to drive the valve 520 (refer to FIGS. 15 and 16). Accordingly, the power consumption of the cooling apparatus 2 may be reduced.

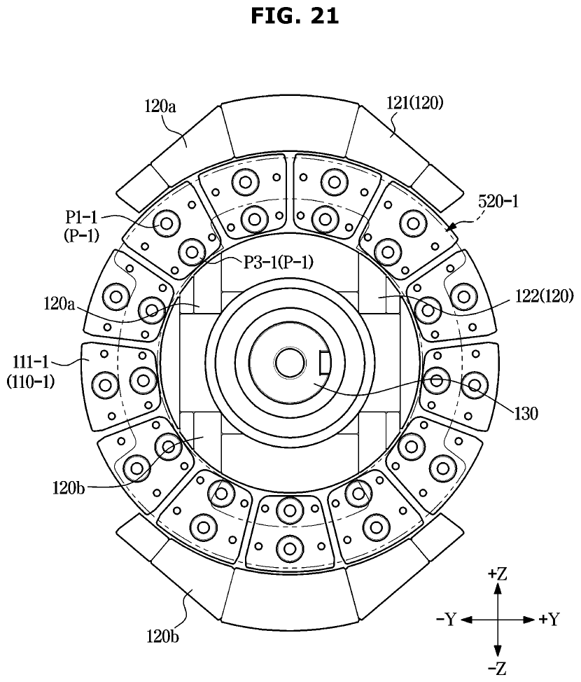

FIG. 21 is a view illustrating a magnetic regeneration portion and a rotary valve according to an embodiment.

Hereinafter, a magnetic regeneration portion 110-1 and a valve 520-1 according to an embodiment of the present disclosure will be described with reference to FIG. 21. In describing the magnetic regeneration portion 110-1 and the valve 520-1, components that are substantially the same as those illustrated in FIGS. 1 to 20 are assigned the same reference numerals, and a repeated description thereof may be omitted.

Referring to FIG. 21, the magnetic regeneration portion 110-1 may include a plurality of magnetic regeneration pipes 111-1. The plurality of magnetic regeneration pipes 111-1 may be arranged with respect to each other in a circle.

The magnetic regeneration portion 110-1 may include a plurality of ports P-1. The plurality of ports P-1 may include a plurality of first inlet ports P1-1 and a plurality of first outlet ports P3-1.

The valve 520-1 may be configured to open and close the plurality of ports P-1. Particularly, the valve 520-1 may be configured to open and close the plurality of first inlet ports P1-1 and the plurality of first outlet ports P3-1.

At least one magnet 120 may include a first magnet 121 and a second magnet 122. The first magnet 121 and the second magnet 122 may form a magnetic field in the magnetic regeneration portion 110-1. Two first magnets 121 and two second magnets 122 may be provided, respectively.

The at least one magnet 120 may include magnet units (e.g., the first magnet unit 120a and the second magnet unit 120b) including the first magnet 121 and the second magnet 122 that are arranged to correspond to each other. The magnet units may include a first magnet unit 120a and a second magnet unit 120b arranged to have a phase difference of 180 degrees with respect to the shaft 130 from the first magnet unit 120a.

The magnet units (e.g., the first magnet unit 120a and the second magnet unit 120b) and the magnetocaloric material M (refer to FIGS. 8 and 9) provided in the magnetic regeneration pipe 111-1 may cause a cogging torque. Cogging torque refers to a resistance torque that may be applied to a driving motor due to magnetic attraction around an object rotated by the driving motor. Each of the first magnet unit 120a and the second magnet unit 120b may induce a cogging torque through the magnetic attraction with the magnetocaloric material M, which may act as resistance to the motor 21 (refer to FIG. 2).

According to an embodiment of the present disclosure, the magnetic regeneration portion 110-1 may include a total of 13 magnetic regeneration pipes 111-1. In this case, the magnetic regeneration portion 110-1 may include a structure that is not symmetrical in the up and down direction (e.g., Z-axis direction) and the left and right direction (e.g., Y-axis direction). With the configuration, a cogging torque induced by the first magnet unit 120a and a cogging torque induced by the second magnet unit 120a may be offset or dispersed from each other, and it may be easier to rotate the at least one magnet 120. Accordingly, the power required for the motor 21 (refer to FIG. 2) may be further reduced.

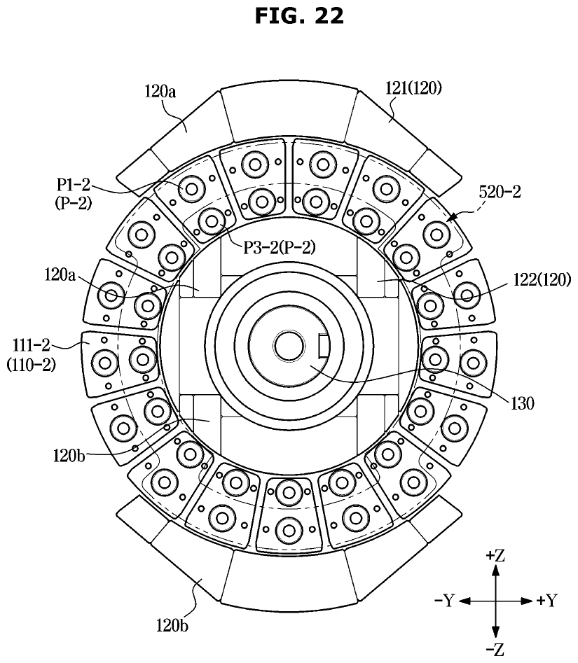

FIG. 22 is a view illustrating a magnetic regeneration portion and a rotary valve according to an embodiment.

Hereinafter, a magnetic regeneration portion 110-2 and a valve 520-2 according to an embodiment of the present disclosure will be described with reference to FIG. 22. In describing the magnetic regeneration portion 110-2 and the valve 520-2, components that are substantially the same as those illustrated in FIGS. 1 to 21 are assigned the same reference numerals, and a repeated description thereof may be omitted.

Referring to FIG. 22, the magnetic regeneration portion 110-2 may include a plurality of magnetic regeneration pipes 111-2. The plurality of magnetic regeneration pipes 111-2 may be arranged with respect to each other in a circle.

The magnetic regeneration portion 110-2 may include a plurality of ports P-2. The plurality of ports P2 may include a plurality of first inlet ports P1-2 and a plurality of first outlet ports P3-2.

The valve 520-2 may be configured to open and close the plurality of ports P-2. Particularly, the valve 520-2 may be configured to open and close the plurality of first inlet ports P1-2 and the plurality of first outlet ports P3-2.

The at least one magnet 120 may include a first magnet unit 120a and a second magnet unit 120b. The first magnet unit 120a and the second magnet unit 120b may be arranged to have a phase difference of 180 degrees with respect to the shaft 130.

The magnetic regeneration portion 110-2 may include a total of 17 magnetic regeneration pipes 111-2. In this case, the magnetic regeneration portion 110-2 may include a structure that is not symmetrical in the up and down direction (e.g., Z-axis direction) and the left and right direction (e.g., Y-axis direction). With the configuration, a cogging torque induced by the first magnet unit 120a and a cogging torque induced by the second magnet unit 120a may be offset or dispersed from each other, and it may be easier to rotate the at least one magnet 120. Accordingly, the power required for the motor 21 (refer to FIG. 2) may be further reduced.

However, the number of magnetic regeneration pipes 111-2 is not limited thereto. For example, the number of magnetic regeneration pipes 111-2 may be a prime number excluding 2. With the configuration, it may be easier to rotate the at least one magnet 120, and the power required for the motor 21 (refer to FIG. 2) may be further reduced.

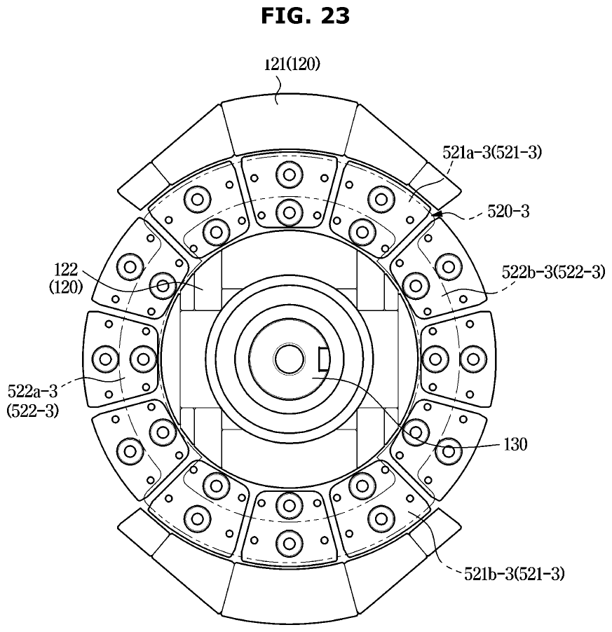

FIG. 23 is a view illustrating a magnetic regeneration portion and a rotary valve according to an embodiment.

Hereinafter a valve 520-3 according to an embodiment of the present disclosure will be described with reference to FIG. 23. In describing the valve 520-3, components substantially identical to those illustrated in FIGS. 1 to 22 are assigned the same reference numerals, and a repeated description thereof may be omitted.

Referring to FIG. 23, the valve 520-3 may include an inlet valve cover 521-3 and an outlet valve cover 522-3. Each of the inlet valve cover 521-3 and the outlet valve cover 522-3 may extend along a circumferential direction of a shaft 130.

A plurality of inlet valve covers 521-3 and a plurality of outlet valve covers 522-3 may be provided. For example, the inlet valve covers 521-3 may include a first inlet valve cover 521a-3 and a second inlet valve cover 521b-3. For example, the outlet valve covers 522-3 may include a first outlet valve cover 522a-3 and a second outlet valve cover 522b-3.

The plurality of inlet valve covers 521-3 and the plurality of outlet valve covers 522-3 may be arranged alternately along the circumferential direction of the shaft 130. In other words, the plurality of inlet valve covers 521-3 and the plurality of outlet valve covers 522-3 may be arranged alternately along a direction in which a plurality of magnetic regeneration pipes 111 is arranged.

For example, each of the first inlet valve cover 521a-3 and the second inlet valve cover 521b-3 may be positioned between the first outlet valve cover 522a-3 and the second outlet valve cover 522b-3 with respect to the circumferential direction of the shaft 130. For example, each of the first outlet valve cover 522a-3 and the second outlet valve cover 522b-3 may be positioned between the first inlet valve cover 521a-3 and the second inlet valve cover 521b-3 with respect to the circumferential direction of the shaft 130.

Each of the plurality of inlet valve covers 521-3 may extend from one end of an outlet valve cover 522-3 adjacent thereto. Additionally, each of the plurality of outlet valve covers 522-3 may extend from one end of an inlet valve cover 521-3 adjacent thereto.

For example, the first inlet valve cover 521a-3 may extend from one end of the first outlet valve cover 522a-3. For example, the second inlet valve cover 521b-3 may extend from one end of the second outlet valve cover 522b-3. For example, the first outlet valve cover 522a-3 may extend from one end of the first inlet valve cover 521a-3. For example, the second outlet valve cover 522b-3 may extend from one end of the second inlet valve cover 521b-3.

At least a portion of the inlet valve cover 521-3 may overlap with at least a portion of the outlet valve cover 522-3 with respect to a radial direction of the shaft 130. Particularly, one end of the inlet valve cover 521-3 may overlap with one end of the outlet valve cover 522-3 with respect to the radial direction of the shaft 130.

For example, the valve 520-3 may include an overlapping portion formed by overlapping one end of the inlet valve cover 521-3 and one end of the outlet valve cover 522-3. That is, the overlapping portion may include one end of the inlet valve cover 521-3 and one end of the outlet valve cover 522-3 that are connected to each other. However, unlike the valve 520 illustrated in FIG. 14, while the valve 520-3 rotates, the overlapping portion may not close the first inlet port P1 and the first outlet port P3 provided in one of the plurality of magnetic regeneration pipes 111.

FIG. 24 is a cross-sectional view of a refrigerator according to an embodiment.

Referring to FIG. 24, the refrigerator 4000 may include the main body 4100 forming an exterior, the storage compartment 4200 provided inside the main body 4100, and a door 4300 rotatably coupled to the main body 4010 to open and close a front opening of the storage compartment 4200.

The storage compartment 4200 may include a refrigerating compartment and a freezing compartment. The refrigerating compartment may be maintained at approximately 0 to 5 degrees Celsius so as to allow food to be refrigerated. The freezing compartment may be maintained at approximately −30 to 0 degrees Celsius so as to allow food to be frozen.

The main body 4100 may include a refrigeration cycle device R configured to supply cold air to the storage compartment 4200. The refrigeration cycle device R may also be referred to as a cold air supply device (refer to FIG. 1).

The refrigeration cycle device R may be configured to include a cooling apparatus 2, a condenser, an expansion valve, and an evaporator E. For example, the condenser may be the first heat exchanger 1a illustrated in FIG. 1, and the evaporator E may be the second heat exchanger 1b illustrated in FIG. 1.

Accordingly, the refrigerant flowing into the cooling apparatus 2 from the condenser may flow along the cooling flow path F2 (refer to FIG. 10) and be cooled. In addition, the refrigerant flowing into the cooling apparatus 2 from the evaporator E may flow along the heating flow path F1 (refer to FIG. 9) and be heated.

A duct 4400 for forming a cooling space 4210 may be formed in the storage compartment 4200. The evaporator E may be disposed in the cooling space 4210. Cold air generated in the evaporator E may be supplied into the storage compartment 4200 through the duct 4400.

A machine room 4220 may be provided inside the storage compartment 4200. For example, the machine room 4220 may be provided at a lower rear side of the storage compartment 4200. The cooling apparatus 2 and the condenser may be disposed in the machine room 4220.

The type of the refrigerator 4000 may not be limited to that shown in FIG. 24. For example, the refrigerator 4000 may be provided in the form of a top mounted freezer (TMF) type refrigerator in which a freezing compartment is formed in an upper portion of a main body and a refrigerating compartment is formed in a lower portion of a main body. For example, the refrigerator 4000 may be provided in the form of a Side By Side (SBS) type refrigerator, and the like. In other words, there is no particular limitation on the type of the refrigerator 4000.

Further, when it is a refrigerator equipped with a system for supplying cold air to a storage compartment, the refrigeration cycle device R including the cooling apparatus 2 may be applied regardless of the type thereof.

FIG. 25 is a perspective view of an air conditioner according to an embodiment. FIG. 26 is an exploded perspective view of an outdoor unit of the air conditioner according to an embodiment.

Referring to FIGS. 25 and 26, the air conditioner 5000 may include the indoor unit 5100 placed in an indoor space, the outdoor unit 5200 placed in an outdoor space, and a refrigerant pipe 5300 that transmits a refrigerant between the indoor unit 5100 and the outdoor unit 5200.

The indoor unit 5100 may exchange heat with indoor air within an air conditioning space. The indoor unit 5100 may perform heat exchange between the refrigerant and indoor air by utilizing a phase change of the refrigerant (e.g., evaporation or condensation). The indoor unit 5100 may include an indoor heat exchanger for generating cold air.

The outdoor unit 5200 may exchange heat with outdoor air outside an air conditioning space. The outdoor unit 5200 may perform heat exchange between the refrigerant and the outdoor air by utilizing a phase change of the refrigerant (e.g., evaporation or condensation).

The refrigerant pipe 5300 may allow the refrigerant to flow between outside the air conditioning space and inside the air conditioning space. Accordingly, the refrigerant pipe 5300 may transfer heat between outside the air conditioning space and inside the air conditioning space.

The outdoor unit 5200 may include an outdoor unit housing 5210 forming an exterior of the outdoor unit 5200. The outdoor unit housing 5210 may be provided to receive various components of the outdoor unit 5200.

The outdoor unit 5200 may include an outdoor heat exchanger 5220 configured to exchange heat with outdoor air, and an outdoor fan 5230 configured to draw in and blow outdoor air to allow the outdoor air to pass through the outdoor heat exchanger 5220. In addition, the outdoor unit 5200 may include an indoor heat exchanger and a cooling apparatus 2 connected to the outdoor heat exchanger 5220.

The indoor heat exchanger, the outdoor heat exchanger 5220, and the cooling apparatus 2 may form the refrigeration cycle device R (refer to FIG. 1). In this case, the outdoor heat exchanger 5220 may be the first heat exchanger 1a shown in FIG. 1, and the indoor heat exchanger may be the second heat exchanger 1b shown in FIG. 1.

Accordingly, the refrigerant flowing into the cooling apparatus 2 from the outdoor heat exchanger 5220 may flow along the cooling flow path F2 (refer to FIG. 10) and be cooled. In addition, the refrigerant flowing into the cooling apparatus 2 from the indoor heat exchanger may flow along the heating flow path F1 (refer to FIG. 9), and be heated.

A heat exchange room R1 may be formed inside the outdoor unit housing 5210. In the heat exchange room R1, heat exchange may occur between the outdoor heat exchanger 5220 and air introduced from the outside. Components such as the outdoor heat exchanger 5220 and the outdoor fan 5230 may be arranged in the heat exchange room R1.

A machine room R2 may be formed in the outdoor unit housing 5210. Components such as the cooling apparatus 2 may be disposed in the machine room R2.

However, the position of the cooling apparatus 2 is not limited thereto. For example, the cooling apparatus 2 may be disposed within the indoor unit 5100.

The outdoor unit 5200 may include a partition 5240 provided to define the heat exchange room R1 and the machine room R2. The partition 5240 may be disposed between the heat exchange room R1 and the machine room R2.

The outdoor unit housing 5210 may include a first front frame 5211 covering a front side of the heat exchange room R1, and a second front frame 5212 covering a front side of the machine room R2. An outdoor unit outlet 5211a for discharging air may be formed in the first front frame 5211.

The outdoor unit housing 5210 may include a first rear frame 5213 covering a rear side of the heat exchange room R1, and a second front frame 5214 covering a rear side of the machine room R2. A first outdoor unit inlet 5213a for introducing air may be formed in the first rear frame 5213.

The outdoor unit housing 5210 may include a first side frame 5215 covering a lateral side of the heat exchange room R1, and a second side frame 5216 covering a lateral side of the machine room R2. A second outdoor unit inlet 5215a for introducing air may be formed in the first side frame 5215.

As the outdoor fan 5230 rotates, air outside the outdoor unit housing 5210 may be drawn in through the outdoor unit inlets (e.g., the first outdoor unit inlet 5213a and the second outdoor unit inlet 5215a), and after exchanging heat with the outdoor heat exchanger 5220, the air may be discharged to the outside of the outdoor unit housing 5210 through the outdoor unit outlet 5211a.

The outdoor unit housing 5210 may include a top cover 5217. The top cover 5217 may cover an upper side of the outdoor unit housing 5210.

The outdoor unit housing 5210 may include a front cover 5218. The front cover 5218 may cover front surfaces of the first front frame 5211 and the second front frame 5212.

A cooling apparatus 2 according to an embodiment includes a magnetic regeneration portion 110 provided to receive a magnetocaloric material M therein and including a plurality of ports P configured to have a refrigerant pass therethrough, at least one magnet 121 configured to rotate around the magnetic regeneration portion 110 on an outside of the magnetic regeneration portion 110, and a valve 520 on a first side of the magnetic regeneration portion 110, and configured to rotate in conjunction with the rotation of the first magnet 121. The valve 520 includes at least one valve cover (e.g., the inlet valve cover 521 and the outlet valve cover 522) configured to open or close some ports P, which are adjacent to each other among the plurality of ports P, based on the rotation of the valve 520.

The plurality of ports P may include a plurality of inlet ports P1 provided to allow the refrigerant to flow into the magnetic regeneration portion 110, and a plurality of outlet ports provided to discharge the refrigerant from the magnetic regeneration portion 110. The at least one valve cover (e.g., the inlet valve cover 521 and the outlet valve cover 522) is a plurality of valve covers. The plurality of valve covers may include at least one inlet valve cover 521 configured to open or close some inlet ports P1, which are adjacent to each other among the plurality of inlet ports P1, based on the rotation of the valve, and at least one outlet valve cover 522 configured to open or close some outlet ports P3, which are adjacent to each other among the plurality of outlet ports P3, based on the rotation of the valve 520.

The cooling apparatus 2 may further include a shaft 130 inside of the magnetic regeneration portion 110 and configured as a rotational axis of the first magnet 121. The plurality of inlet ports P1 and the plurality of outlet ports P3 may be arranged along a circumferential direction of the shaft 130, the plurality of inlet ports P1 are spaced apart from the plurality of outlet ports P3 along radial directions of the shaft 130. The at least one inlet valve cover 521 may be configured to overlap with the plurality of inlet ports P1. The at least one outlet valve cover 522 may be configured to overlap with the plurality of outlet ports P3.

Each of the at least one inlet valve cover 521 and the at least one outlet valve cover 522 may extend along the circumferential direction of the shaft 130.

The plurality of inlet ports P1 may include a first inlet port P11, and a second inlet port P12 spaced apart from the first inlet port P11 along the circumferential direction of the shaft 130. The plurality of outlet ports P3 may include a first outlet port P31, wherein the first inlet port P11 and the first outlet port P31 are arranged from the shaft 130 in a first radial direction of the shaft 130, and a second outlet port P32, wherein the second inlet port P12 and the second outlet port P32 are arranged from the shaft 130 in a second radial direction of the shaft 130. The at least one outlet valve cover 522 may be configured to close both the first outlet port P31 and the second outlet port P32 in a case where both the first inlet port P11 and the second inlet port P12 are opened by the at least one inlet valve cover 521.

The at least one inlet valve cover 521 may be configured to close both the first inlet port P11 and the second inlet port P12 in a case where both the first outlet port P31 and the second outlet port P32 are opened by the at least one outlet valve cover 522.

The at least one inlet valve cover 521 may be a plurality of inlet valve covers 521. The plurality of inlet valve covers 521 may include a first inlet valve cover 521a, and a second inlet valve cover 521b spaced apart from the first inlet valve cover 521a along the circumferential direction of the shaft 130. The at least one outlet valve cover 522 may be a plurality of outlet valve covers 522. The plurality of outlet valve covers 522 may include a first outlet valve cover 522a, and a second outlet valve cover 522b spaced apart from the first outlet valve cover 522a along the circumferential direction of the shaft 130.

The first inlet valve cover 521a may be between the first outlet valve cover 522a and the second outlet valve cover 522b in the circumferential direction of the shaft 130. The first outlet valve cover 522a may be between the first inlet valve cover 521a and the second inlet valve cover 521b in the circumferential direction of the shaft 130.

The cooling apparatus 2 may further include a first case 560 provided to cover the valve 520, and a valve holder 530 provided to support the valve 520 on an inside of the first case 560.

The first case 560 may include a first case inlet 561 provided to allow the refrigerant to flow into the first case 560, and a first case outlet 562 provided to discharge the refrigerant from the first case 560. The first case inlet 561 may be configured to communicate with inlet ports P1, among the plurality of inlet ports P1, opened by the at least one inlet valve cover 521. The first case outlet 562 may be configured to communicate with outlet ports P3, among the plurality of outlet ports P3, opened by the at least one outlet valve cover 522.

The valve holder 530 may include a holder base 531 in contact with the valve 520, and a holder body 532 protruding from the holder base 531. The cooling apparatus 2 may further include an inlet flow path F3 between an outer surface of the holder body 532 and an inner surface of the first case 560, and extending from the first case inlet 561 to the inlet ports P1, among the plurality of inlet ports P1, that are opened by the at least one inlet valve cover 521.

The valve holder 530 may include a holder base 531 in contact with the valve 520, a holder body 532 protruding from the holder base 531, and a shaft support 533 arranged on an inner side of the holder body 532 and provided to support the shaft 130. The cooling apparatus 2 may further include an outlet flow path F4 between an inner surface of the holder body 532 and an outer surface of the shaft support 533, and extending from the outlet ports P3, among the plurality of outlet ports P3, that are opened by the at least one outlet valve cover 522 to the first case outlet 562.

The cooling apparatus 2 may further include an elastic member 550 between the first case 560 and the valve holder 530, the elastic member 550 configured to press the valve holder 530 toward the valve 520.

At least a portion of the at least one inlet valve cover 521 may overlap with at least a portion of the at least one outlet valve cover 522 in a radial direction of the shaft 130.

The at least one inlet valve cover 521-3 may extend from one end of the at least one outlet valve cover 522-3. The at least one outlet valve cover 522-3 may extend from one end of the at least one inlet valve cover 522-3.

A cooling apparatus 2 according to an embodiment may include a magnetic regeneration portion 110 provided to receive a magnetocaloric material M therein and including a plurality of ports P through which a refrigerant is introduced or discharged, a magnet 121 configured to rotate around the magnetic regeneration portion 110 to form a magnetic field in the magnetic regeneration portion 110, and a valve 520 configured to open and close the plurality of ports P on one side of the magnetic regeneration portion 110 and configured to rotate in conjunction with the rotation of the first magnet 121. A control method of the cooling apparatus 2 may include inducing rotation of the valve 520 by rotating the first magnet 121 (3000) so as to open or close some ports P that are adjacent to each other among the plurality of ports P.

The valve 520 may be configured to rotate in the same rotational direction as the first magnet 121.

A rotational angular velocity of the valve 520 may be the same as a rotational angular velocity of the first magnet 121.

The first magnet 121 may be a first magnet 121 configured to rotate on an outside of the magnetic regeneration portion 110. The cooling apparatus 2 may further include a second magnet 122 configured to rotate on an inside of the magnetic regeneration portion 110. The plurality of ports P may include a plurality of inlet ports P1 provided to allow a refrigerant to flow into the magnetic regeneration portion 110. While the valve 520 rotates, inlet ports P1 closed among the plurality of inlet ports P1 may be located between the first magnet 121 and the second magnet 122.

The plurality of ports P may further include a plurality of outlet ports P3 provided to discharge a refrigerant from the magnetic regeneration portion 110. While the valve 520 rotates, outlet ports P3 opened among the plurality of outlet ports P3 may be located between the first magnet 121 and the second magnet 122.

According to an embodiment of the present disclosure, a cooling apparatus may include a rotary valve configured to open and close a plurality of ports of a magnetic generation portion as the rotary valve rotates. That is, the cooling apparatus may not require a solenoid valve for opening and closing the plurality of ports.

Further, a cooling apparatus may open and close a plurality of ports through a single rotary valve. Therefore, the cooling apparatus may have a relatively small volume.

Further, a rotary valve may open and close a plurality of ports by rotating in conjunction with rotation of a magnet. Accordingly, a cooling apparatus may not require separate power to drive the rotary valve, and power consumption of the cooling apparatus may be reduced.

Further, a rotary valve may not include a separate device for instantaneously opening or closing each of a plurality of ports. Therefore, the rotary valve may not generate a striking noise between components during opening and closing of the plurality of ports, and noise generated during operation of a cooling apparatus may be reduced.

While non-limiting example embodiments of the present disclosure have been described above with reference to the accompanying drawings, it should be understood by those of skilled in the art that various changes in form and details may be made without departing from the spirit and scope of the present disclosure.

What is claimed is:

1. A cooling apparatus comprising:
a magnetic regeneration portion configured to receive a magnetocaloric material therein, the magnetic regeneration portion comprising a plurality of ports, the plurality of ports configured to have a refrigerant pass therethrough;
a magnet configured to rotate around the magnetic regeneration portion on an outside of the magnetic regeneration portion; and
a valve on a first side of the magnetic regeneration portion, the valve configured to rotate in conjunction with rotation of the magnet,
wherein the valve comprises at least one valve cover configured to open or close some ports, which are adjacent to each other among the plurality of ports, based on rotation of the valve.

2. The cooling apparatus of claim 1, wherein
the plurality of ports comprises:
a plurality of inlet ports configured to allow the refrigerant to flow into the magnetic regeneration portion; and
a plurality of outlet ports configured to discharge the refrigerant from the magnetic regeneration portion,
wherein the at least one valve cover is a plurality of valve covers, the plurality of valve covers comprising:
at least one inlet valve cover configured to open or close some inlet ports, which are adjacent to each other among the plurality of inlet ports, based on the rotation of the valve; and
at least one outlet valve cover configured to open or close some outlet ports, which are adjacent to each other among the plurality of outlet ports, based on the rotation of the valve.

3. The cooling apparatus of claim 2, further comprising:
a shaft inside the magnetic regeneration portion, the shaft configured as a rotational axis of the magnet,
wherein the plurality of inlet ports and the plurality of outlet ports are arranged along a circumferential direction of the shaft, and the plurality of inlet ports are spaced apart from the plurality of outlet ports along radial directions of the shaft,
wherein the at least one inlet valve cover is configured to overlap with the plurality of inlet ports; and
wherein the at least one outlet valve cover is configured to overlap with the plurality of outlet ports.

4. The cooling apparatus of claim 3, wherein
each of the at least one inlet valve cover and the at least one outlet valve cover extends along the circumferential direction of the shaft.

5. The cooling apparatus of claim 3, wherein
the plurality of inlet ports comprises:
a first inlet port; and
a second inlet port spaced apart from the first inlet port along the circumferential direction of the shaft,
wherein the plurality of outlet ports comprises:
a first outlet port, wherein the first inlet port and the first outlet port are arranged from the shaft in a first radial direction of the shaft; and
a second outlet port, wherein the second inlet port and the second outlet port are arranged from the shaft in a second radial direction of the shaft,
wherein the at least one outlet valve cover is configured to close both the first outlet port and the second outlet port in a case where both the first inlet port and the second inlet port are opened by the at least one inlet valve cover.

6. The cooling apparatus of claim 5, wherein
the at least one inlet valve cover is configured to close both the first inlet port and the second inlet port in a case where both the first outlet port and the second outlet port are opened by the at least one outlet valve cover.

7. The cooling apparatus of claim 3, wherein
the at least one inlet valve cover is a plurality of inlet valve covers, the plurality of inlet valve covers comprising:
a first inlet valve cover; and
a second inlet valve cover spaced apart from the first inlet valve cover along the circumferential direction of the shaft,
wherein the at least one outlet valve cover is a plurality of outlet valve covers, the plurality of outlet valve covers comprising:
a first outlet valve cover; and
a second outlet valve cover spaced apart from the first outlet valve cover along the circumferential direction of the shaft.

8. The cooling apparatus of claim 7, wherein
the first inlet valve cover is between the first outlet valve cover and the second outlet valve cover in the circumferential direction of the shaft; and
the first outlet valve cover is between the first inlet valve cover and the second inlet valve cover in the circumferential direction of the shaft.

9. The cooling apparatus of claim 3, further comprising:
a case configured to cover the valve; and
a valve holder configured to support the valve on an inside of the case.

10. The cooling apparatus of claim 9, wherein
the case comprises:
a case inlet configured to allow the refrigerant to flow into the case; and
a case outlet configured to discharge the refrigerant from the case,
the case inlet is configured to communicate with inlet ports, among the plurality of inlet ports, opened by the at least one inlet valve cover; and
the case outlet is configured to communicate with outlet ports, among the plurality of outlet ports, opened by the at least one outlet valve cover.

11. The cooling apparatus of claim 10, wherein
the valve holder comprises:
a holder base in contact with the valve; and
a holder body protruding from the holder base, and
the cooling apparatus further includes an inlet flow path between an outer surface of the holder body and an inner surface of the case, the inlet flow path extending from the case inlet to the inlet ports, among the plurality of inlet ports, that are opened by the at least one inlet valve cover.

12. The cooling apparatus of claim 10, wherein
the valve holder comprises:
a holder base in contact with the valve;
a holder body protruding from the holder base; and
a shaft support arranged on an inner side of the holder body and provided to support the shaft,
the cooling apparatus further includes an outlet flow path between an inner surface of the holder body and an outer surface of the shaft support, the outlet flow path extending from the outlet ports, among the plurality of outlet ports, that are opened by the at least one outlet valve cover to the case outlet.

13. The cooling apparatus of claim 9, further comprising:
an elastic member between the case and the valve holder, the elastic member configured to press the valve holder toward the valve.

14. The cooling apparatus of claim 3, wherein
at least a portion of the at least one inlet valve cover overlaps with at least a portion of the at least one outlet valve cover in a radial direction of the shaft.

15. The cooling apparatus of claim 3, wherein
the at least one inlet valve cover extends from one end of the at least one outlet valve cover; and
the at least one outlet valve cover extends from one end of the at least one inlet valve cover.

16. A cooling apparatus comprising:
a magnetic regeneration portion configured to receive a magnetocaloric material; the magnetic regeneration portion comprising a plurality of ports, the plurality of ports configured to have a refrigerant pass therethrough;
a magnet configured to rotate around the magnetic regeneration portion such as to form a magnetic field in the magnetic regeneration portion; and
a valve on one side of the magnetic regeneration portion, the valve configured to open and close the plurality of ports and rotate in conjunction with rotation of the magnet.

17. The cooling apparatus of claim 16, wherein
the plurality of ports comprises:
a plurality of inlet ports configured to allow the refrigerant to flow into the magnetic regeneration portion; and
a plurality of outlet ports configured to discharge the refrigerant from the magnetic regeneration portion.

18. The cooling apparatus of claim 17, further comprising:
a shaft inside the magnetic regeneration portion, the shaft configured as a rotational axis of the magnet,
wherein the plurality of inlet ports and the plurality of outlet ports are arranged along a circumferential direction of the shaft, and the plurality of inlet ports are spaced apart from the plurality of outlet ports along radial directions of the shaft.

19. The cooling apparatus of claim 18, further comprising:
a case configured to cover the valve; and
a valve holder configured to support the valve on an inside of the case.

20. A method performed by at least one processor, the method comprising:
rotating a motor of a cooling apparatus, wherein the rotating comprises:
causing a magnet of the cooling apparatus to rotate around a magnetic regeneration portion of the cooling apparatus such as to form a magnetic field in the magnetic regeneration portion, wherein the magnetic regeneration portion includes a magnetocaloric material and a plurality of ports, the plurality of ports configured to have a refrigerant pass therethrough; and
causing a valve of the cooling apparatus to open or close the plurality of ports and rotate in conjunction with rotation of the magnet, wherein the valve is on one side of the magnetic regeneration portion.
